(19) United States
(12) Patent Application Publication
(10) Pub. No.: US 2018/0096274 A1
(43) Pub. Date: Apr. 5, 2018

(54) DATA MANAGEMENT SYSTEM AND METHODS OF MANAGING RESOURCES, PROJECTS, FINANCIALS, ANALYTICS AND DASHBOARD DATA

(71) Applicant: 3 Fuerzas Technology Solutions, LLC, Overland Park, KS (US)

(72) Inventor: Elizabeth M. DeZeeuw, Overland Park, KS (US)

(21) Appl. No.: 15/282,874

(22) Filed: Sep. 30, 2016

(51) Int. Cl. G06Q 10/06; H04L 29/08; G06F 7/08

(52) U.S. Cl. CPC G06Q 10/06315; H04L 67/22; G06F 7/08; H04L 67/12

(57) ABSTRACT

A computer implemented method for managing resource information between an associate and a client relating to a client assignment. The method includes receiving a plurality of associate parameters; storing the plurality of associate parameters on a database; analyzing the plurality of associate parameters; assigning a ranking of the associate based at least one of the plurality of associate parameters; receiving a plurality of client parameters; performing a matching analysis by comparing the plurality of client or project parameters to the plurality of associate parameters; and assigning the associate to the client based at least on the matching analysis.

### CROSS-REFERENCE TO RELATED APPLICATION

This non-provisional application claims priority to U.S. Provisional Patent Application Ser. No. 62/235,815, filed on Oct. 1, 2015, which is hereby incorporated by reference in its entirety.

### BACKGROUND

The embodiments described herein relate to an integrated data management system, and more particularly, to data management systems and methods for receiving, managing, analyzing, and transmitting information relating to, human capital (resources), projects, financials, analytics, time management and dashboards.

For some work projects, the management of personnel resources can be planned using a project management software package. Projects are built upon the definition of phases and tasks that are interrelated in accomplishing a deliverable. Project management packages require the user to build a project template and then assign users to the project. Some project management tools over the years have evolved in the ability to build complex relationships between project phases and tasks while building sophisticated tracking reports to support an enterprise view of a company's projects and tasks.

Some project management packages assign resource workers to conduct the project tasks and or assignments. Some resource workers, however, may not have the required parameters such as, but not limited to, skills, proficiency, experience, permits, certifications, languages, education and availability to efficiently and economically complete the project task and/or assignment. A need exists for a reliable, efficient, and cost effective resource management system for review, vetting, and/or matching of the right human capital to the right project task and/or assignment.

### SUMMARY

In an aspect, a computer implemented method for managing resource information between an associate and a client relating to a client assignment is provided. The method includes receiving a plurality of associate parameters; storing the plurality of associate parameters on a database; analyzing the plurality of associate parameters; assigning a ranking of the associate based at least one of the plurality of associate parameters; receiving a plurality of client parameters; performing a matching analysis by comparing the plurality of client or project parameters to the plurality of associate parameters; and assigning the associate to the client based at least on the matching analysis.

In another aspect, a computer device for managing resource information between an associate and a client or project is provided. The computer device includes a memory device configured to store the resource information An interface device is coupled to the memory device and configured to receive input instructions. A processor is coupled to the memory device and the interface device. The processor is programmed to: receive a plurality of associate parameters; store the plurality of associate parameters on a database; analyze the plurality of associate parameters; assign a ranking of the associate based at least on the plurality of associate parameters; receive a plurality of client parameters; perform a matching analysis by comparing the plurality of client parameters to the plurality of associate parameters; and assign the associate to the client or project based at least on the matching analysis.

In a further aspect, one or more non-transitory computer-readable media having computer- executable instructions embodied thereon for managing resource information using a computer device having a memory and a processor. When executed by the processor, the computer-executable instructions cause the processor to: receive a plurality of associate parameters; store the plurality of associate parameters on a database; analyze the plurality of associate parameters; assign a ranking of the associate based at least on the plurality of associate parameters; receive a plurality of client or project parameters; perform a matching analysis by comparing the plurality of client or project parameters to the plurality of associate parameters; and assign the associate to the client or project based at least on the matching analysis.

### DRAWINGS

These and other features, aspects, and advantages will become better understood when the following detailed description is read with reference to the accompanying drawings in which like characters represent like parts throughout the drawings, wherein:

FIG. 1 is a schematic view of an exemplary integrated data management system;

FIG. 2 is a flowchart illustrating an exemplary method of enrolling or updating information relating to an associate into a skills database of the integrated data management system;

FIG. 3 is a flowchart illustrating an exemplary method of a client resource selection process of the integrated data management system;

FIG. 4 is a flowchart illustrating an exemplary method of matching an associate with a client for the integrated data management system;

FIG. 5 is an exemplary flowchart illustrating an exemplary method of analyzing historical database information and using the historical database information to project future trends based on system calculations and user expressed variables;

FIG. 6 is an exemplary flowchart and table illustrating an exemplary method of determining resource availability based on defined variables and selectable criteria;

FIG. 7 is an exemplary flowchart illustrating an exemplary method of analyzing resource criteria such as salary, skills, certifications or an extended period of time to determine trends in resource development and job title attributes that relate to such criteria;

FIG. 8 is an exemplary flowchart illustrating an exemplary method of creating and maintaining resource attributes and hiring criteria used by the system;

FIG. 9 is an exemplary flowchart illustrating an exemplary method of the Project Intake process where a set of predefined data is entered and the system scores the intake data, and then is routed via an intelligent workflow to the correct reviewers and/or approvers;

FIG. 10 is an exemplary flowchart illustrating and exemplary method of the behavioral analytics used by the system to provide objective data related to each resource, assist in the selection of high functioning teams and determine promotion candidates based on the analysis provided;

FIG. 11 is an exemplary screenshot of an application integrated portal of the integrated data management system;

FIG. 12 is an exemplary screenshot of a client master parameter of assistance;

FIG. 13 are exemplary screenshots of an exemplary client project parameter of the system;

FIG. 14 is an exemplary screenshot of an exemplary project dashboard of the system;

FIG. 15 is an exemplary screenshot of an exemplary language parameter of the system;

FIG. 16 is an exemplary screenshot of an exemplary position/job title parameter of the system;

FIG. 17 is an exemplary screenshot of an exemplary skills parameter of the system;

FIG. 18 is an exemplary screenshot of an exemplary certifications parameter of the system;

FIG. 19 is an exemplary screenshot of an exemplary resource company parameter of the system;

FIG. 20 is an exemplary screenshot of an exemplary resource criminal record parameter of the system;

FIG. 21 are exemplary screenshots of an exemplary resource master parameter of the system;

FIG. 22 is an exemplary screenshot of an exemplary resource previous employment parameter of the system;

FIG. 23 is an exemplary screenshot of an exemplary resource team parameter of the system;

FIG. 24 is an exemplary screenshot of an exemplary resource travel parameter of the system;

FIG. 25 is an exemplary screenshot of an exemplary special skills parameter of the system;

FIG. 26 is an exemplary screenshot of an exemplary spoken/written languages parameter of the system;

FIG. 27 is an exemplary screenshot of a survey questions parameter of the system;

FIG. 28 is an exemplary screenshot of an exemplary survey results parameter of the system;

FIG. 29 is an exemplary screenshot of a dashboard/dashboard parameter of the system;

FIG. 30 is an exemplary screenshot of a position/job title parameter of the system;

FIG. 31 is an exemplary screenshot of a certification parameter of the system;

FIG. 32 is an exemplary screenshot of a resource company parameter of the system;

FIG. 33 is an exemplary screenshot of a resource master parameter of the system;

FIG. 34 are exemplary screenshots of a resource master summary parameter of the system;

FIG. 35 is an exemplary screenshot of a criminal records parameter of the system;

FIG. 36 is an exemplary screenshot of an education parameter of the system; and

FIG. 37 is an exemplary screenshot of a travel detail visa or work permit parameter of the system.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

The embodiments described herein relate to enterprise systems and methods of an integrated data management system, and more particularly, to data management systems and methods for receiving, managing, analyzing, and transmitting information relating to a company's human capital. The embodiments include a robust mobile portal, a self-service capability, integrations between vendor, client and provider systems and the ability to provide multi-layered security for industries such as, for example only; legal, healthcare, financial and transportation. The system is configured to locate the relevant resource(s) worldwide by utilizing a multilingual (English, Spanish, etc.) global professional skills matrix database that contains enrolled associates unique characteristics in order to provide the highest efficiency matching by relevance, cost and time of need for the required skill set. The database is continuously reviewed and updated by the users to ensure data is kept current. The last change date can be stored with each of the characteristics to ensure the most current information is available.

Relevance matching includes skill(s) such as, but not limited to: needed, proficiency, spoken and/or written language(s) required and proficiency, availability, proximity, time zone, certifications needed, resource availability, education required, previous work ratings based on incorporated survey system and any relevant cultural considerations. Each associate's background check information is available along with visa and/or work permit status.

By acting as a hub, users can access the pool of skilled talent and maximize the utilization of resources throughout the enterprise ensuring that both the customers and the company's needs are met quickly and efficiently.

When resources are needed, the client utilizes the guided graphical user interface to enter the comprehensive selection criteria. That selection criteria is then matched against the available global resources to provide the best fit including assembling multiple teams from disparate locations. The system is configured to maximize performance, and cost effective resources are chosen based on availability.

The selection efficiency is continuously enhanced through the use of the incorporated survey/rating system results to identify the highest rated associates that are available. Upon completion of a task/project, associates are graded by the client on a variety of key performance metrics which are stored with the associate's profile in the skills matrix database.

The system incorporates analytics to provide feedback on key performance indicators and dashboards of current and historical metrics. This information provides feedback on the progress of the engagement, efficiency and cost effectiveness of the staff. The system includes the information needed to ensure the most efficient use of resources. By integrating the database (IODb) algorithm for selecting resources, reporting and analytics, survey feedback mechanism and executive and detailed dashboards, the system facilitates a complete solution for managing offshoring/nearshoring/onshore resources.

The multilingual professional skills matrix database contains unique characteristics of enrolled information technology (IT) resources in order to provide the highest efficiency matching of the most qualified resource by relevance, cost and time of need for the required skill set. Continual updates ensure data is kept current. The selection efficiency is continuously enhanced through the use of the incorporated survey rating system results to identify the highest rated associates that are available. Upon completion of a project, associates are graded by the client on a variety of key performance metrics which are stored with the associate's profile in the skills matrix database.

The system incorporates advanced analytics to provide feedback on key performance indicators and a dashboard of current and historical metrics. This information provides feedback on the progress of the engagement, efficiency and cost effectiveness of the resources.

In the exemplary embodiments, human capital can refer to terms such “resources”, “associates”, “employee”, “client”, “company”, and “employer”. Moreover, these terms can be used interchangeably. In the exemplary embodiment, the descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The system also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The embodiments can take the form of an entirely hardware embodiment, an entirely software embodiment or an embodiment containing both hardware and software elements. In an exemplary embodiment, the system is implemented in software, which includes but is not limited to firmware, resident software, microcode, etc.

Furthermore, the embodiments can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system of the embodiments suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or “I/O” devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The software, algorithm and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the embodiments are described with reference to a particular programming language. It will be appreciated that a variety of programming languages may be used to implement the teachings of the invention as described herein.

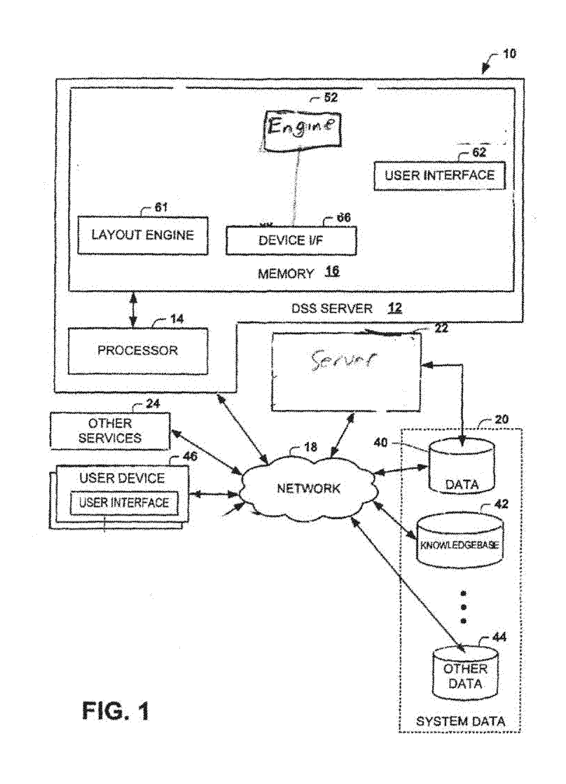

FIG. 1 depicts an example of an integrated data management system 10 for evaluating and matching an associate with a client. In the exemplary embodiment, an associate can include a worker such as, but not limited to, an onshore worker, offshore worker, a nearshore worker, an employee, an agent, and a contract worker. Moreover, the client can include a customer, employer, entity, and/or person requesting work. The management system 10 includes a server 12. The server 12 can include one or more processors 14 and a memory 16. In the figures, the system 10 or components of the system 10 such as the processor 14 and the memory 16 can be referred to as “EDZSytem”. The memory 16 can store data and machine readable instructions that can be executed by the processor 14. For example, the memory 16 can comprise physical memory, such as can reside on the processor 14 (for example, processor memory), random access memory or other physical storage media (for example, CD-ROM, DVD, flash drive, hard disc drive, etc.) or a combination of different memory devices that can store the machine readable instructions. The memory 16 further can be implemented within a single machine or device (for example, laptops or mobile phones), or it can be distributed across multiple machines or devices. The data utilized for implementing the systems and methods described herein can also be stored in the memory 16 or in some other arrangement of one or more memory structures that are accessible for use by the management system 10.

The server 12 can be connected to a network 18 such as to provide for communication between the management server and various services, devices and data stores that can collectively form the system 10. The network 18 can be a local area network, a wide area network, or a combination of different various network topologies, which may include physical transmission media (for example, electrically conductive, optical fiber media or the like) and/or wireless communications media, that can be utilized for communicating information. The network or at least a portion of the methods and functions implemented thereby can operate in a secure manner (for example, behind a firewall separated from public networks) and/or utilize encryption for data communications. As a further example, the server 12 can be implemented as a computing cloud in which the functions and methods and data can be accessible as a service via the network 18.

The server 12 can employ the network 18 to access system data 20, an encounter server 22, as well as one or more other services generally indicated at 24. These other services 24 can correspond to various other servers that can store and provide information pertinent to a given associate and/or client. Such other services 24 may also execute methods and functions that can be utilized by the server 12, such as via corresponding application interfaces (APIs). The particulars of such other services 24 can vary according to the particular purpose of the management system 10.

In addition to associate data and client data that may be stored in a database 40, the server 12 can also access a knowledgebase 42 or one or more other data sources, indicated at 44. The knowledgebase 42 can be utilized to access a variety of information and matching algorithms that may be utilized by users of the system 10. Such information contained in the knowledgebase 42 or the other data sources 44 may be accessed via a search engine. The server 12 can make such information available to its users via dynamic or configurable links. As an example, the server 12 can present information to a user via one or more web (for example, html) pages that contain dynamic links (for example, hypertext links) to predefined resource locations (for example, uniform resource locations (URLs)) at which pertinent information corresponding to the system data 20 can be provided. As disclosed herein, the server 12 can be programmed to automatically select the information according to the real-time conditions of the associate and/or client, preferences of the user, guidance expressions and other information related to an associate input, client request, and/or matching decisions relative to the associate and client. The server 12 can provide an encounter GUI (for example, a page) that is populated with such selected information and/or links to such information.

Authorized users can also employ one or more corresponding user devices 46 to access information generated by the server 12. There can be any number of user devices 46 that can access the information from the server 12. A given user device 46 can include a user interface 48 that allows the user to access the functions and methods implemented by the server 12 as well as to retrieve related content information. The user interface 48, for example, can include a web browser (or a thin client application) that can be provided dynamic links for accessing the functions and methods corresponding to the server 12. It is to be appreciated that such user device 46 can be a computer, a work station, as well as a mobile device (for example, a smart phone, laptop or tablet computer) that can run a corresponding application programmed to access the functions and methods associated with the server 12. The user device 46 can be located in a corresponding local area as well as can be implemented as a remote device that can access the information produced by the server 12, such as by accessing corresponding pages via a web browser or other application.

The server 12 can include an engine 52 programmed to evaluate information and data pertinent to an evolving associate enrollment and/or client selection process. The engine 52 can receive the data from various inputs, as well as from data available from other sources such as the system data 20, the encounter server 22 and other services 24. The engine 52 can be programmed to analyze such information based on one or more expressions and compute decision support data that can be employed to populate a visualization space that is presented to one or more users. The engine 52 can also be programmed to search the system data 20 or other sources for pertinent associate enrollment and/or client selection process. For example, the system 10 can automatically generate matching criteria by populating the visualization space with relevant information and/or links to information stored in the knowledgebase 42 or in the other data 44. Data acquired by the server 12 can be stored in the memory 16 or another database, such as may be part of the system data 20.

The system 10 can also include an engine 61 that is programmed to control populating the layout of a visualization space. The layout can include a static layout, a dynamic layout or a combination of static and dynamic layouts. A static layout, for example, can be configured to provide guidance and support data for each of one or more predefined positions in a visualization space. For example, a user can select a set of locations (for example, different associates) and the layout engine 61 can populate the visualization space with a GUI element to provide guidance information for each selected location. In this example, the layout engine 61 can populate the visualization space with the GUI element for each location statically (for example, regardless of the results of any expressions). The engine 61 can also dynamically populate the visualization space based on one or more expressions that are assigned to visualization space. For example, a user can assign an expression to a place holder in the visualization space and only populate the space with a corresponding GUI element depending on the results of the assigned expression. Thus, if the expression criteria is met, the engine 61 can dynamically add a GUI element and if (or when) the criteria is not met any longer, the GUI element can be removed from the visualization space. In this way, the system 10 can employ one or more selected expressions to dynamically control populating a layout based on encounter data.

A user can employ the user interface 62 of the server 12 that can access corresponding tools, such as may be part of a manager 64. The manager 64 can correspond to functions and methods that can be utilized to program or various aspects of the system 10, such as disclosed herein. The accessibility of various functions and methods that can be accessed by a given user can depend upon an individual's authorization or role within the system. For example, there can be any range of roles that can be established within the system 10, which may be based upon existing authentication systems for an enterprise or network in which the system 10 is being implemented. For instance, a supervisor or other individual with a sufficient level of authorization can set the parameters for controlling the global guidance module 58.

A system administrator further may be able to create and configure interfaces, such as including one or more device interfaces 66, to control communication and retrieval of data from various resources in the system 10. The device interface 66 thus can create a communications channel via the network for retrieving relevant data. The retrieved data can include raw data, processed data or a combination of raw and process data that can be presented in the form of content to a given user. Additionally, an individual user may also employ the user interface 62 to access personal preferences via the manager 64, such as to establish parameters that control the personal guidance module 60 for such user, set up user devices 46 and other personal settings. In the embodiment described herein, the term “system”, “processor”, and “server” can be used interchangeably.

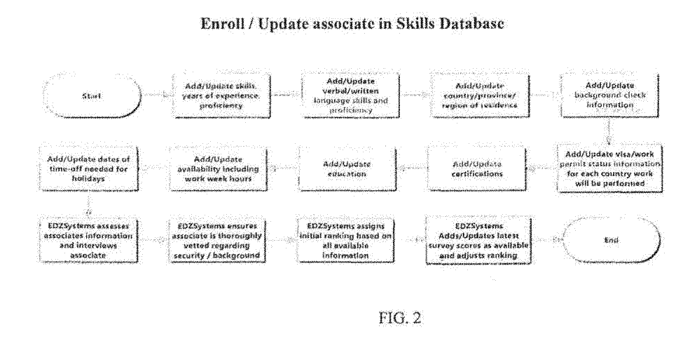

FIG. 2 is a flow chart illustrating a method of enrolling and/or updating an associate information into a database of the data management system 10. The processor 14 is configured to receive a plurality of associate parameters sent or transmitted by the associate. The plurality of associate parameters includes information relating to the associate. The processor 14 can receive an initial plurality of associate parameters. The processor 14 is configured to enroll the associate by inputting into the system database 20 the initial plurality of associate parameters. Alternatively, the processor 14 can receive a subsequent plurality of associate parameters. The processor 14 configured to update the associate by inputting into the database the subsequent plurality of associate parameters.

In the exemplary embodiment, the plurality of associate parameters includes, but is not limited to: a skill parameter, a years of experience parameter: a verbal/written language skills parameter; a country/province/region of residence parameter; a background check parameter; a visa/work permit status information for each country where work will be performed parameter; a certification parameter; an education parameter; work availability parameter; a time off needed for holidays parameter; a position/job title parameter; a resource company parameter; a previous employment parameter; a survey question parameter; a survey result parameter. In the exemplary embodiment, the processor 14 is configured to add/update the skills and years of experience parameter into the database. The processor 14 is configured to add/update the verbal/written language parameter into the database. Moreover, the processor 14 is configured to add/update the country/province/region of residence parameter into the database. The processor 14 is configured to add/update the background check parameter into the database. Additionally, the processor 14 is configured to add/update the visa/work permit status information for each country worked parameter into the database. The processor 14 is configured to add/update the certification parameter into the database. Still further, the processor 14 is configured to add/update the education parameter into the database. The processor 14 is configured to add/update the work week availability parameter into the database. The processor 14 is configured to add/update the holiday time off needed parameter into the database.

The processor 14 is configured to analyze and assess the associate based at least on the receipt plurality of associate parameters. The processor 14 is configured to schedule an interview with the associate. The processor 14 is configured to review/vet the associate regarding security and background information. Moreover, the processor 14 is configured to assign an initial ranking of the associate based at least on the received associate parameters. The processor 14 is configured to add/update any previous survey scores received from the client that relate to the associate. Moreover, the processor 14 can adjust the ranking of the associate based at least on the summary scores. Based at least on the processor 14 controller and/or updating the associate parameter in the database 20, the processor 14 is configured to evaluate the associate and recommend a match to the client or client's project.

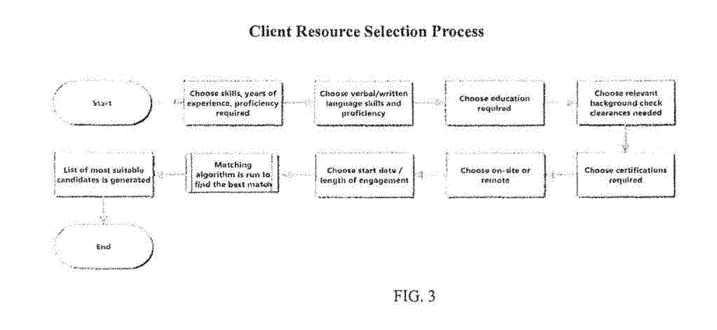

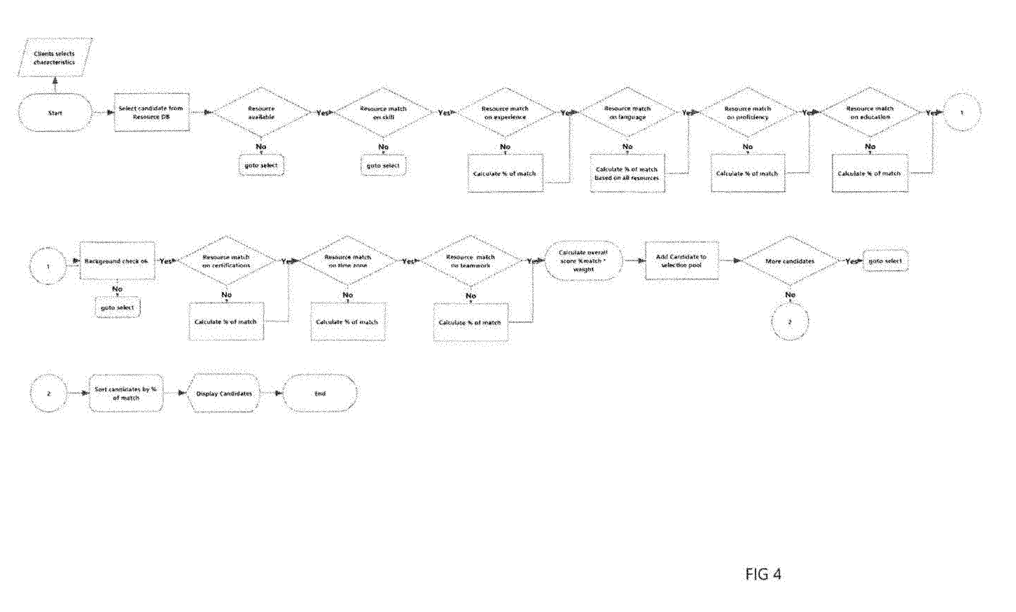

FIG. 3 is a flowchart illustrating a method of selecting a client resource selection process of the integrated data management system 10. The processor 14 is configured to receive the plurality of client parameters sent or transmitted by the client or customer. The plurality of a client parameter includes information relating to a client's needs and/or requests. In the exemplary embodiment, the plurality of client parameters includes, but in not limited to: a skills parameter, a years of experience parameter; a proficiency parameter; a verbal/written language skills parameter; an education parameter; a background check parameter; a certifications parameter; an onsite or remote parameter; a start date/length of engagement parameter. The client parameter can include the same parameter information as described by the associate parameter.

The processor 14 is configured to choose at least one of a skill, years of experience and proficiency based on the client parameter. The processor 14 is also configured to choose a verbal/written language skills and proficiency based on the client parameter. The processor 14 is configured to choose an education required parameter based on the client parameter. Moreover, the processor 14 is configured to choose relevant background check for clearance as needed based on the client parameter. The processor 14 is configured to choose certifications required based on the client parameter. The processor 14 is configured to choose an onsite or remote location based on the client parameter. Additionally, the processor 14 is configured to choose a start date/length of engagement based on the client parameter. In the exemplary embodiment, the processor 14 is configured to execute or calculate a preferred match of an associate with the client based at least on comparing the client's needs relative to the client parameters to the associate parameters. The processor 14 is configured to list suitable associates generated based on the matching execution or calculation parameter in the processor 14.

FIG. 4 is a flowchart illustrating an exemplary method of matching the associate with the client for the integrated data management system 10. In the exemplary embodiment, for the matching sequence, the processor 14 is configured to receive the client request based at least on the plurality of client parameters. The processor 14 is configured to select a candidate from the resource database. The processor 14 is configured to determine if resource is available and determine a resource match based on at least the skill parameter. Moreover, the processor 14 is configured to determine the resource match based at least on the experience parameter. In an embodiment, the processor 14 is configured in an embodiment to calculate a percentage of the resource match on experience. Additionally, the processor 14 is configured to determine a resource match based on language. In an embodiment, the processor 14 is configured to calculate a percentage of the resource match based on the resources relating to language. In an embodiment, the processor 14 is configured to calculate a percentage of the resource match based on proficiency. Still further, the processor 14 is configured to determine a resource match based on education. In an embodiment, the processor 14 is configured to calculate a percentage of the resource match based on the education.

The processor 14 is configured to determine whether the background check is cleared. The processor 14 is configured to determine resource match based on the certification. In an embodiment, the processor 14 is configured to calculate a percentage of the resource match based on the certification. The processor 14 is configured to determine a resource match based on the time zone. In an embodiment, the processor 14 is configured to calculate a percentage of the resource match based on the time zone. The processor 14 is configured to determine a resource match based on teamwork. In an embodiment, the processor 14 is configured to calculate a percentage of the resource match based on the teamwork.

The processor 14 is configured to calculate an overall score percentage match with or without weighted factors. The processor 14 is configured to add associates to the selection pool. The processor 14 is configured to sort the associates by percentages of the match and display the associates for future selection of matching the associate with the client.

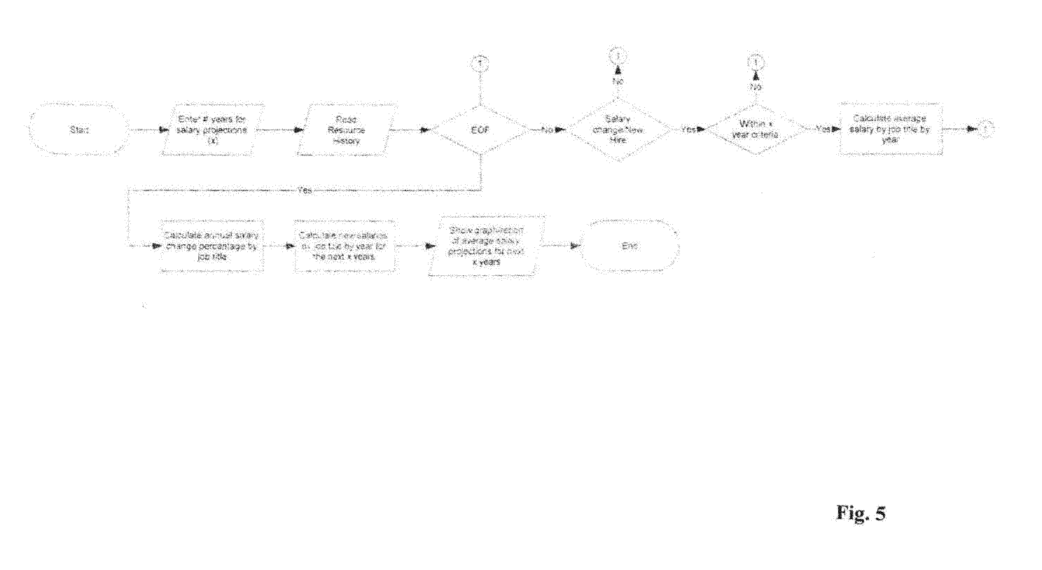

FIG. 5 is a flowchart illustrating a method used by the system 10 of analyzing historical database information and using the historical database information to project and/or calculate future trends based on system calculations and user-expressed variables. During the analysis of the historical database information, the processor 14 is configured to receive a salary variable such as, for example, the number of years for salary projections. The salary variable can be received by the process report 14 from a user input. Alternatively, the salary variable can be received by the processor 14 from the memory 16. The processor 14 is configured to receive a resource history relating the associate. The resource history variable can be received by the processor 14 via user input and/or from the memory 16. The resource history variable includes historical information and changes related to the associate that has been stored by the system 10 to be used for data analysis. The data analysis can include a comparison between sets of critical, trending information that can be used in future projections.

An end-of-file (“EOF”) decision is determined by the client user or by the processor 14 based at least on the salary variable and the resource history variable. If the decision is affirmative, then the processor 14 is configured to calculate annual salary change percentage by job title. The processor 14 is also configured to calculate new salaries by job title, by year for a number of future years. The processor 14 is configured to generate or present a graph and/or report of average salary projections for the next predetermined number of years. If the EOF decision is negative, the processor is configured to calculate whether a new salary change/new hire is warranted. If the decision is in the negative, then the processor is configured to return to the selection criteria for another associate evaluation. The information for the denied associate can be returned to the selection criteria for future consideration/evaluation. . If the salary change/new hire decision is in the affirmative, the processor 14 is configured to determine the salary change/new hire within a predetermined year criteria. The processor is then configured to calculate average salary by job title, by year.

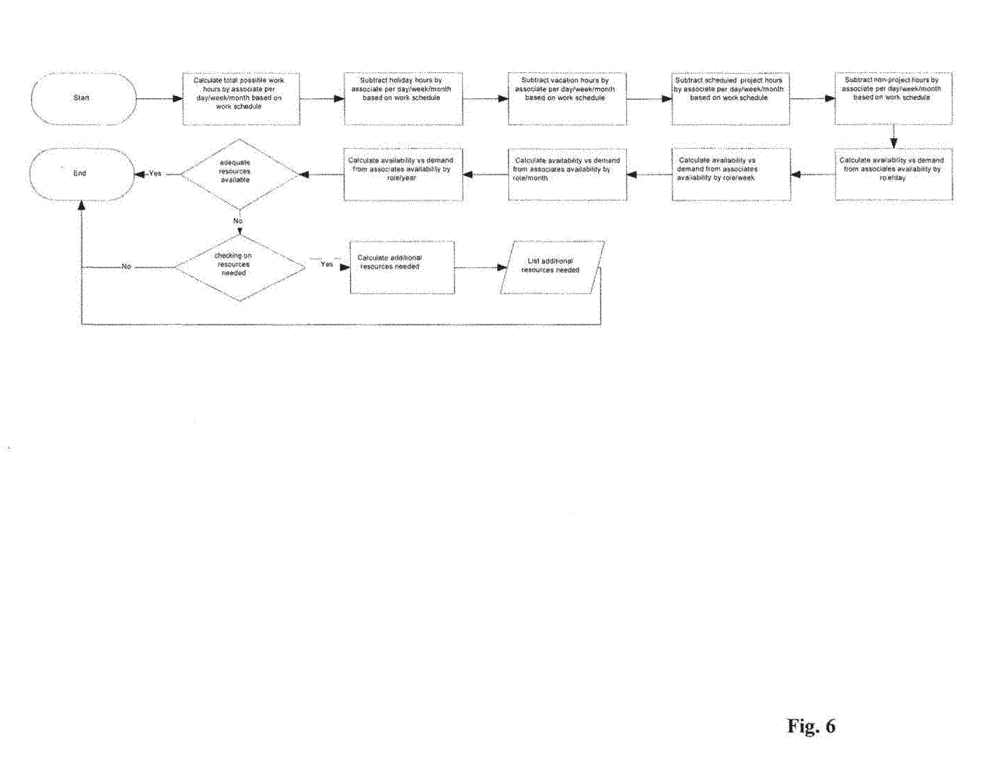

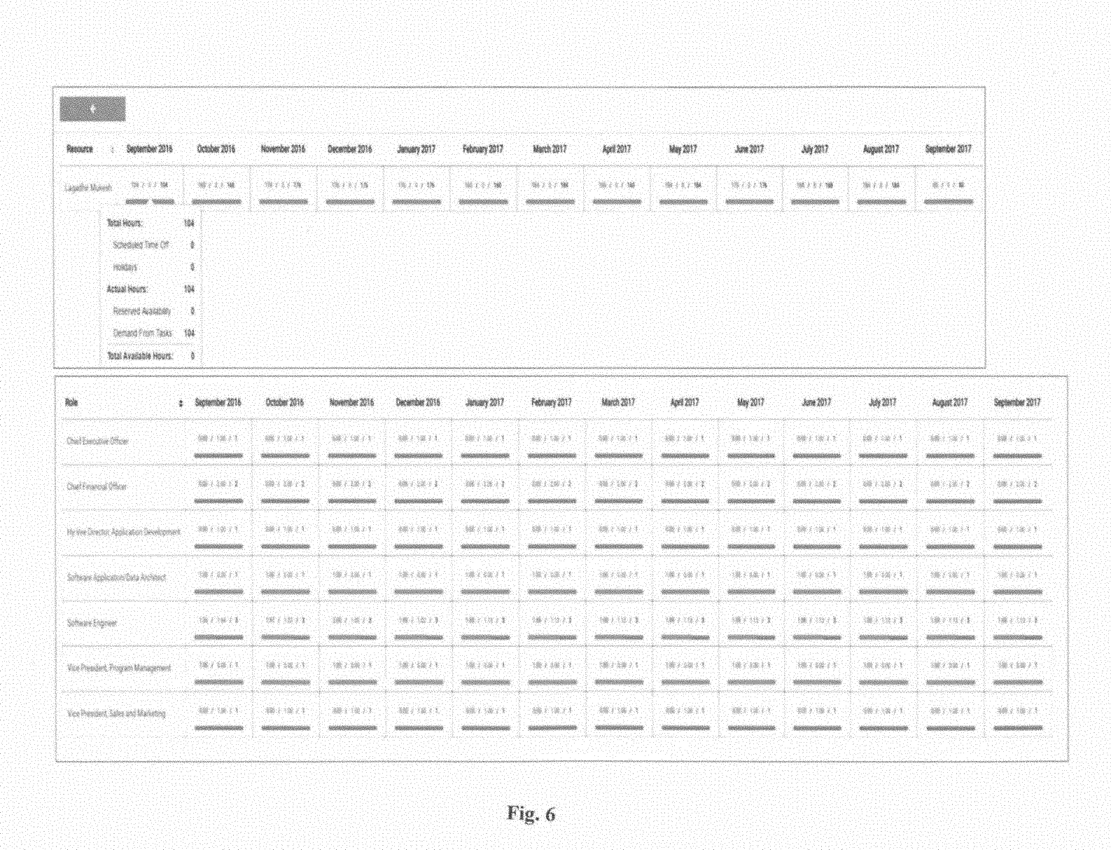

FIG. 6 is a flowchart and a table illustrating a method of determining resource availability based on defined variables and selectable criteria. For example, the processor 14 is configured to calculate total possible work hours by an associate per day/week/month based on a work schedule. The processor 14 is configured to subtract holiday hours by associate per day/week/month based on the work schedule. Moreover, the processor 14 is configured to subtract vacation hours by associate per day/week/month based on the work schedule. Additionally, the processor 14 is configured to subtract scheduled project hours by associate per day/week/month based on the work schedule. Non-project hours are subtracted by the processor 14 per associate per day/week/month based on the work schedule.

The processor 14 is configured to calculate availability versus demand from associate's availability by role/day. Additionally, the processor 14 is configured to calculate availability versus demand from associate's availability by role per week. Moreover, the availability versus demand from associate's availability by role/month is calculated by the processor 14. The processor 14 further calculates availability versus demand from associate's availability by role per year.

The processor is then configured to decide whether adequate resources are available. If the decision is in the affirmative, the processor 14 sequence for determining resource availability is complete, wherein the processor 14 is configured to match the associate with the client. If the decision by the processor 14 for adequate resources available is in the negative, the processor is configured to check on resources needed. If no further resources are needed, the processor 14 is configured to complete the method of determining resource availability. If the processor 14 determines that further resources are needed, the processor 14 calculates the required additional resources and lists the additional resources needed to complete the sequence for determining resource availability. Moreover, in determining the resource availability, the processor 14 is configured to graphically display a plurality of rules over a predetermined period of time. In particular, for particular job roles over time, the processor 14 is configured to graphically represent demand hours for the resources, the hours available to work on other projects, and the total hours remaining in the month for each role. As an example for the Chief Executive Officer noted for September 2016, the processor 14 is configured to list firs the demand hours (0.0; second the work available hours for other projects (1.0); and, third the total hours remaining in the month (0,0).

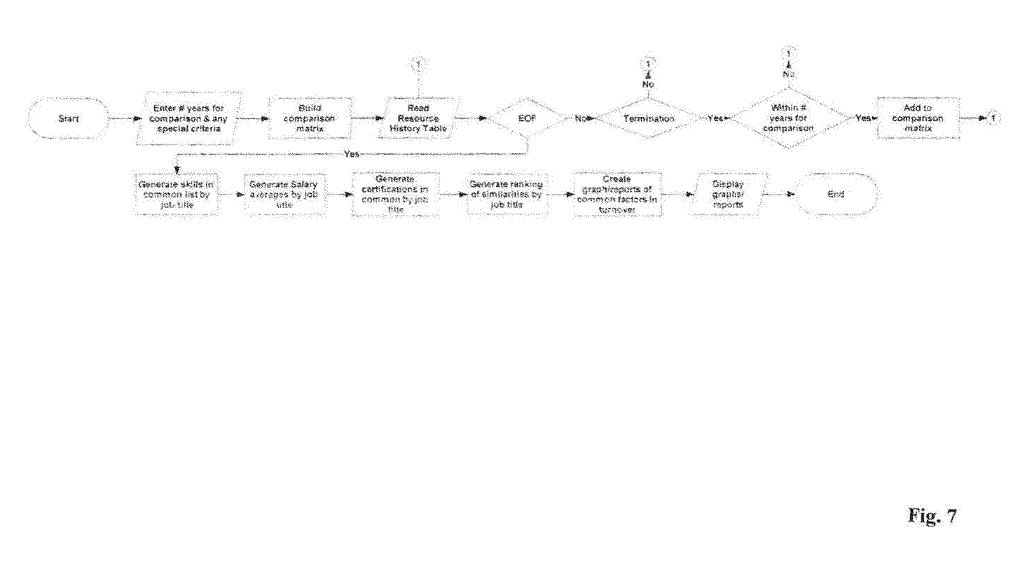

FIG. 7 is a flowchart illustrating a method of analyzing resources criteria such as, for example, salary, skills, and certifications for an extended period of time to determine trends in resource development and job title attributes that relate to such criteria. The processor 14 is configured to receive a variable such as the number of years for comparison and any special criteria. The years variable can be received by the processor 14 from a user input. Alternatively, the years variable can be received by the processor 14 from the memory 16. The processor 14 is configured to build a comparison matrix based on the received variables. Moreover the processor 14 is configured to receive the resource history variable as previously described.

An EOF decision is determined by the client user or the processor 14. If the decision is affirmative, the processor 14 is configured to generate skills in common with a list by job title. Additionally, the processor 14 is configured to generate salary averages by job title. Moreover, the processor 14 is configured to generate certificates in common by job title. The processor 14 is configured to generate ranking of similarities by job title. Moreover, the processor 14 is configured to create graphs/reports of common factors in turnover. These graphs/reports are displayed by the processor 14. If the EOF decision is in the negative, the processor 14 is configured to determine whether to terminate the associate. If the determination is affirmative, the processor 14 is configured to determine within number of years for comparison and then subsequently add the comparison to the comparison matrix. If the determination is negative, the processor 14 is configured to return the associate information to the selection criteria as previously described.

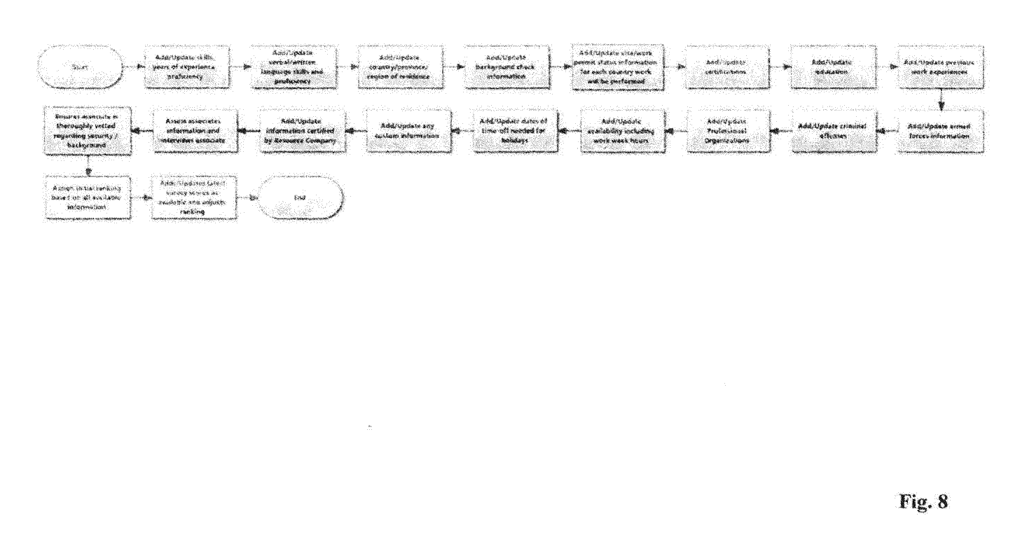

FIG. 8 is a flowchart illustrating a method of creating and maintaining resource attributes in hiring criteria used by the system 10. The processor 14 is configured to add/update skills, years of experience, and proficiency. Moreover, verbal/written language skills and proficiency are added/updated by the processor 14. The processor 14 is configured to add/update country/province/region of residence. Moreover, background check information is added/updated by the processor 14. The processor 14 further adds/updates visas/work permit status information for each country worked that will be performed. Moreover, other parameters such as certifications, education, and previous work experiences are added/updated by the processor 14. Moreover, other parameters such as armed forces information, criminal offenses, and professional organizations are added/updated by the processor 14. Processor 14 is configured to add/update availability including work time such as, for example, work week hours and holiday time off needed. The processor 14 is configured to add/update any custom information or information certified by a particular resource company.

The processor 14 assesses associate's information and schedules an interview for the associate. The processor 14 is configured to check or vet regarding issues such as security and background. Initial rankings based on all available information is assigned by the processor 14. Moreover, the latest survey scores as available are added/updated by the processor 14 wherein the processor 14 is configured to adjust the associate's ranking.

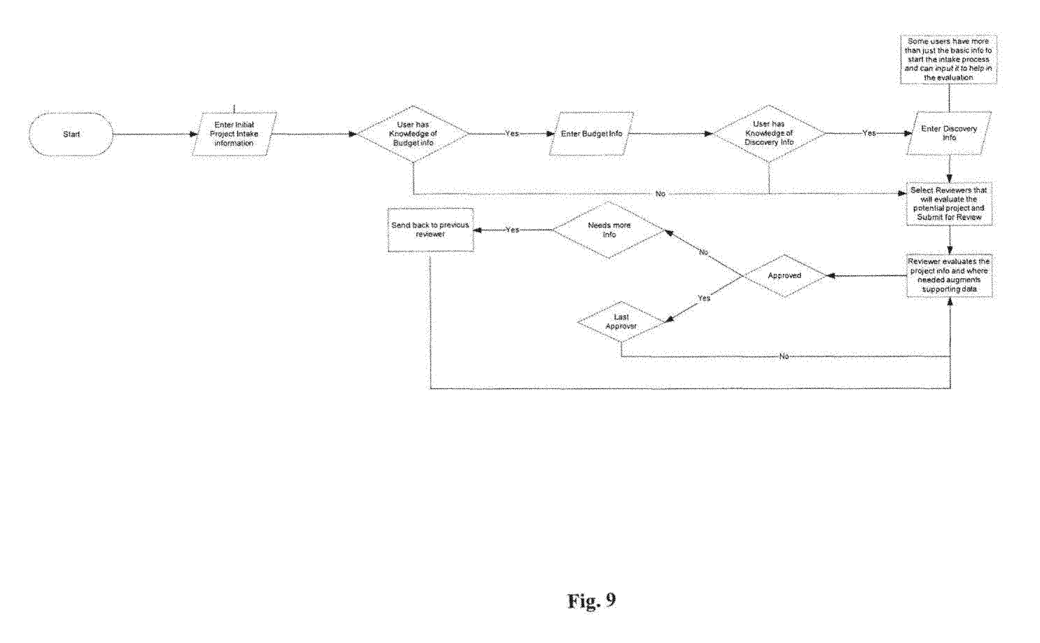

FIG. 9 is a flowchart illustrating a method of a project intake process where a set of predefined data is entered in the system 10 and is configured to calculate scores of the intake data. The system is configured to route an intelligent workflow to the correct reviewer and/or approver. The processor 14 is configured to receive project intake information. The project intake information can be received by the processor 14 by user input. Alternatively, the project intake information can be received by the processor 14 from the memory 16. The processor 14 is configured to receive the budget information from client user input or from the memory 16. Additionally, a knowledge of discovery info is determined by the processor 14. The processor 14 is configured to receive the discovery information which can be user input or received from the memory 16. The discovery information includes user provided information used to populate an intake form which is then routed via workflow for review, approval or returned for addition information. If approved, the data in the intake form is used to create the project in the projects section of the tool automatically, which facilitates reducing the duplication of work and ties the intake form to the project for a complete lifecycle view of the end-to-end process. Processor 14 is configured to select a reviewer's submittal for approval.

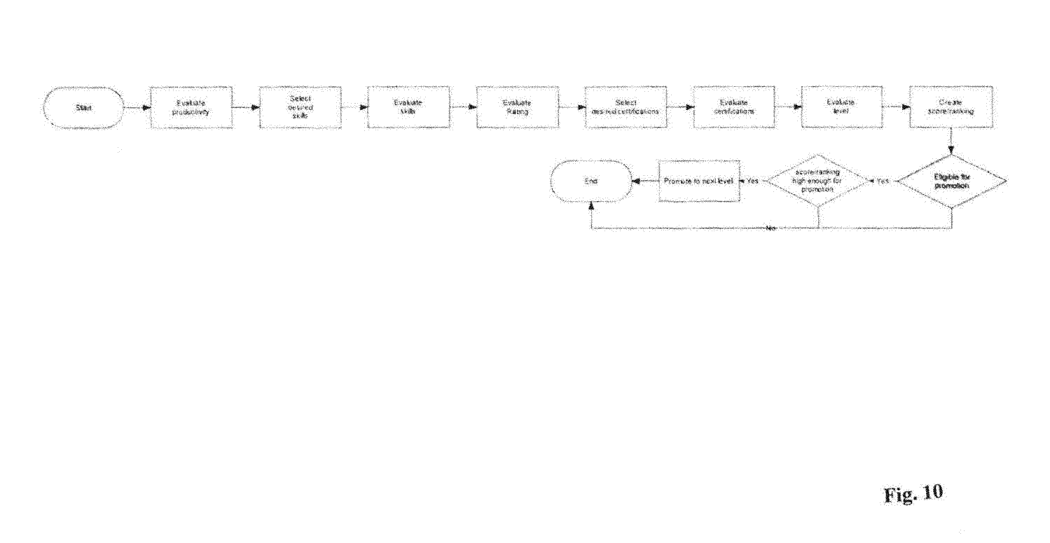

FIG. 10 is a flowchart illustrating a method of behavioral analytics used by the system 10 to provide objective data related to each resource. Processor 14 is configured to facilitate in the selection of high-functioning teams and determine promotion candidates based on the analysis. Processor 14 is configured to evaluate productivity in select desired skills. Upon selecting the desired skills, the processor 14 is configured to evaluate the skills and evaluate the rating of the associate. Processor 14 is configured to select desired certification and evaluate the associate's certification. The skill level of the associate is evaluated by the processor 14 and the processor 14 is configured to create a score/ranking for the associate. Processor 14 is configured to decide whether the associate is eligible for promotion. If the promotion decision is in the negative, then the processor 14 is configured to note the ineligibility. If the promotion decision is in the affirmative, the processor 14 is configured to score/rank the associate high enough for a promotion. If the score/ranking is high enough for promotion, the processor 14 is configured to promote the associate to the next level.

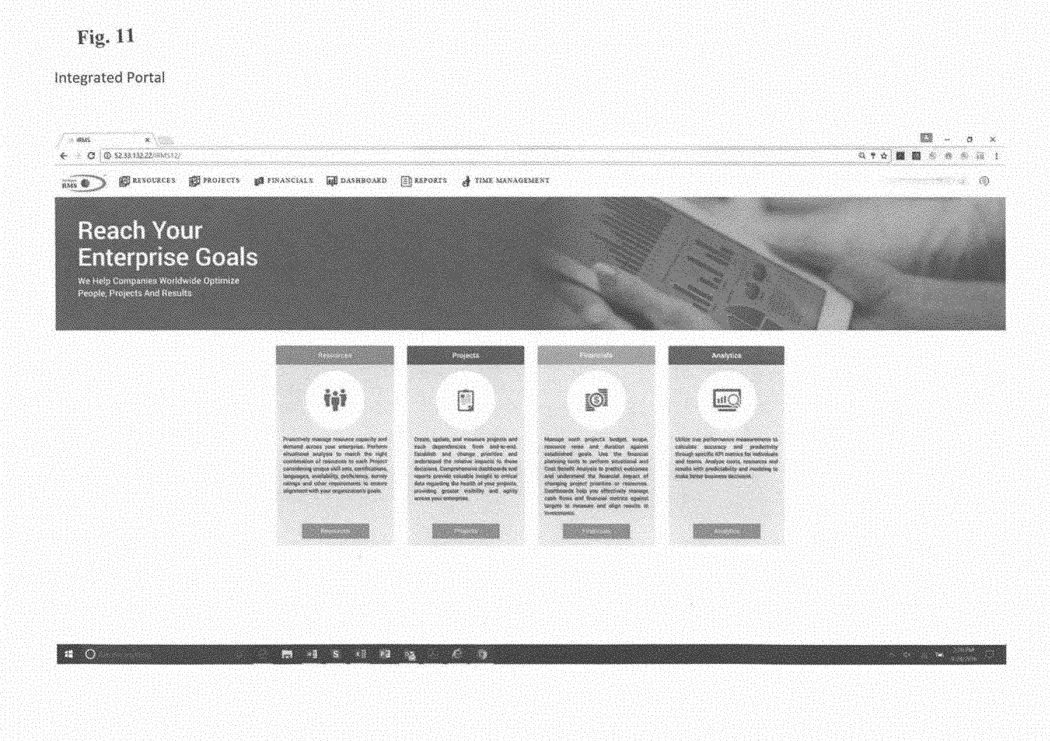

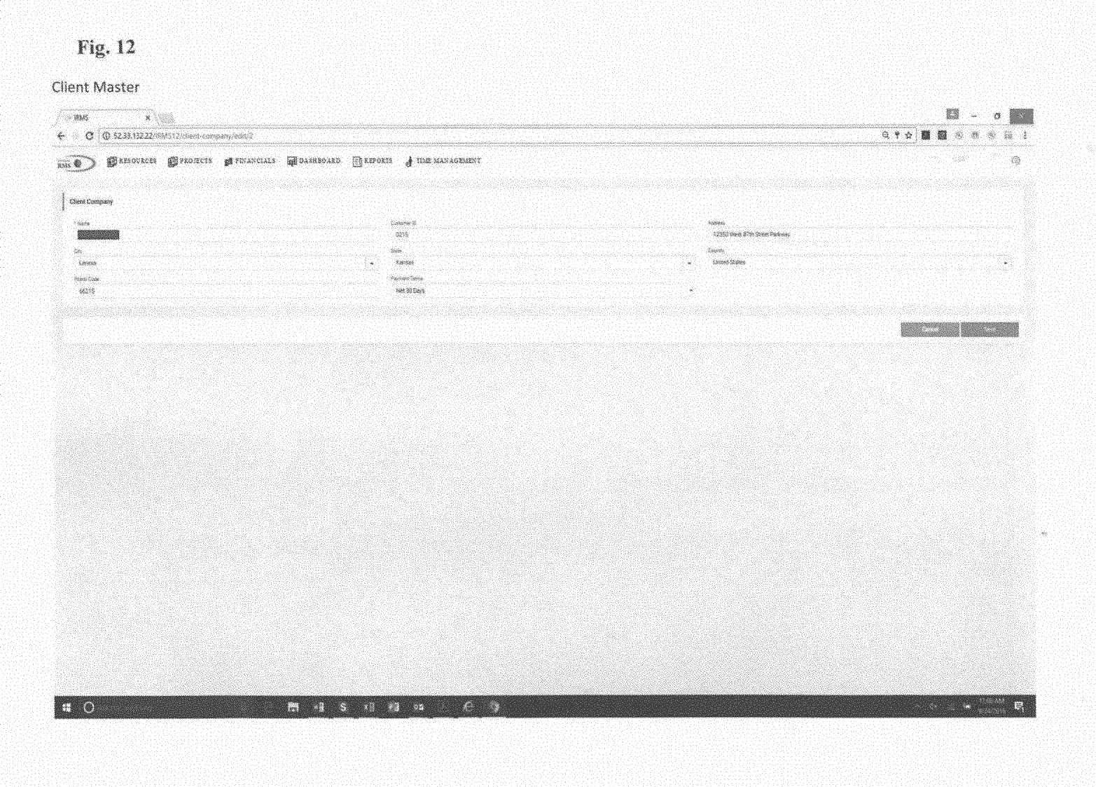

FIG. 11 is a screenshot of an application integral portal of the system 10. In the exemplary embodiment, the system 10 is configured to facilitate obtaining a plurality of objectives/goals such as, for example only, resource goals, project goals, financial goals, and analytical goals. FIG. 12 is an exemplary screenshot of a client master parameter of the system 10. The client master parameter presents client information such as, for example, name, address and customer identification number associated with a particular client. For the resource goals, the processor 14 is configured to facilitate proactive managed resource capacity and demand across the client's enterprise. The processor 14 is configured to perform situational analysis to match the right combination of resources to each product considering unique skill sets, certifications, languages, availability, proficiency, survey ratings and other requirements to assure alignment with the client or organizational goals. For the projects goal, the processor 14 is configured to create, update, and measure projects and track dependencies from end to end. The processor 14 is configured to establish and change priorities and understand the relative impact to those decisions. Comprehensive dashboards and reports provided by the processor 14 provide valuable insight to critical data regarding the health of the projects which can provide greater visibility and agility across the enterprise.

For the financial goals, the processor 14 is configured to manage each project's budget, scope, resource rates, and duration against established goals. The processor 14 is configured to use the financial planning tools to perform situational and cost/benefit analysis to predict outcomes and understand the financial impact of changing project resources or priorities. The created dashboards facilitate managing cash flow and financial metrics against targets to measure and align results to investments. For the analytics goal, the processor 14 is configured to utilize true performance measurements to calculate accuracy and productivity through specific key performance indicator metrics for individuals and teams. Processor 14 is configured to analyze costs, resources, and results with predictability and modeling to facilitate better business decisions.

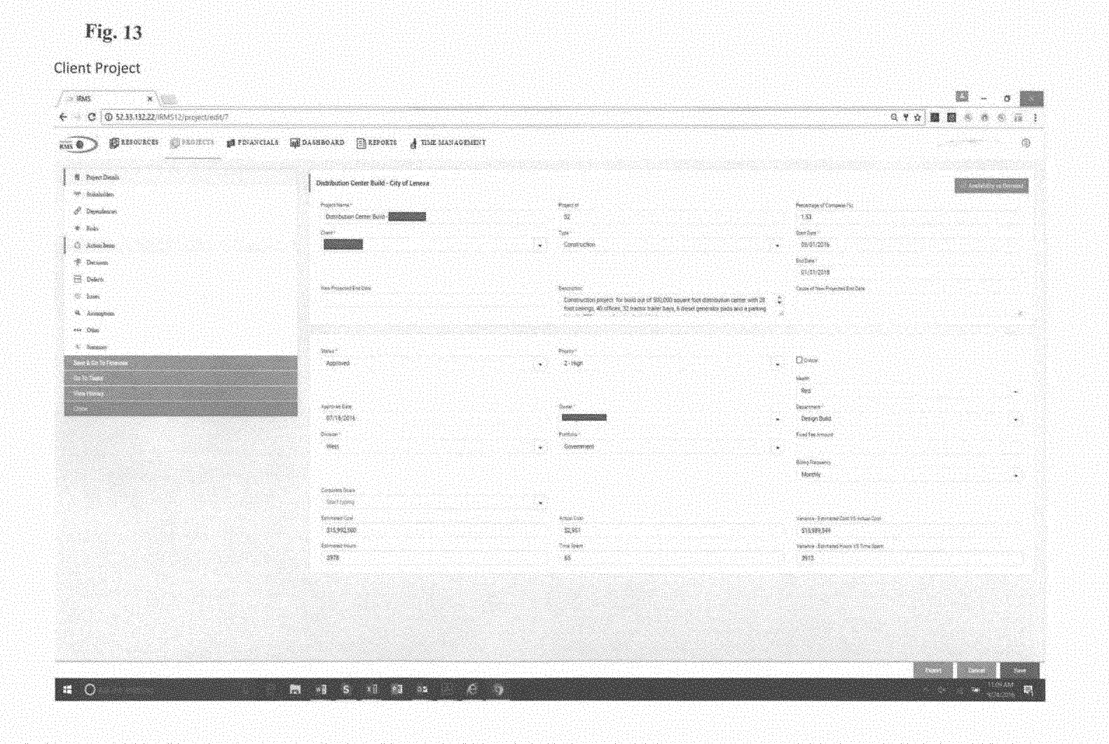

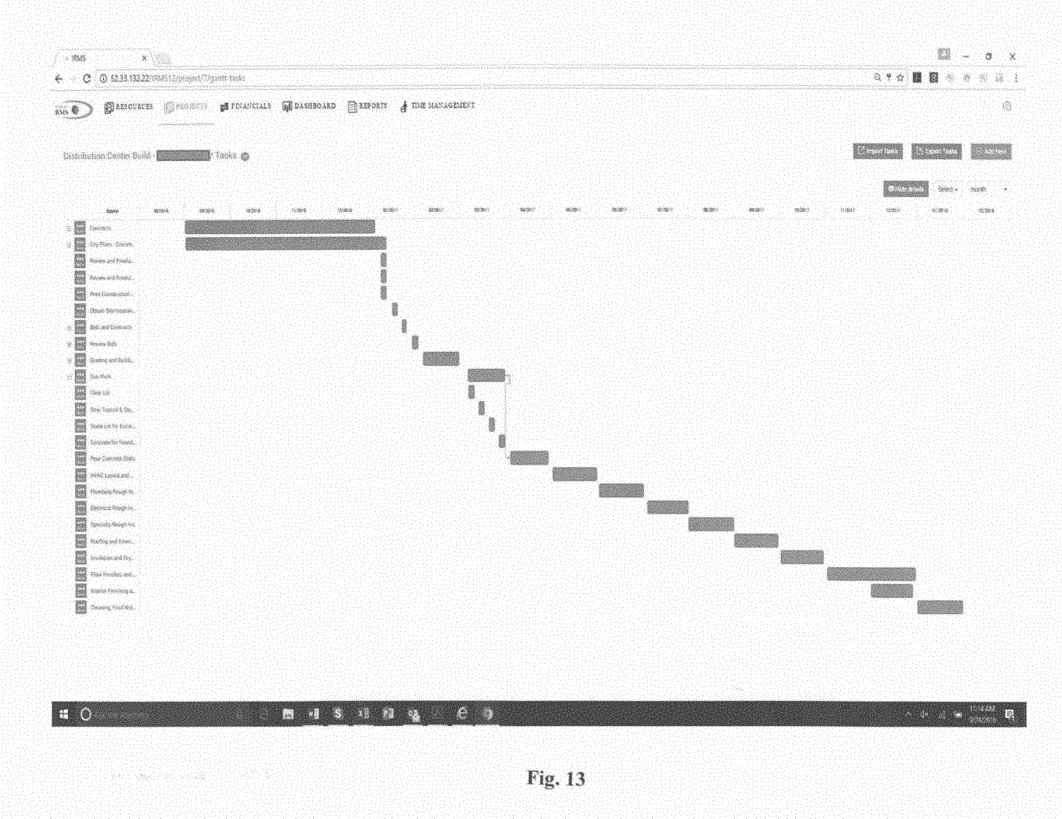

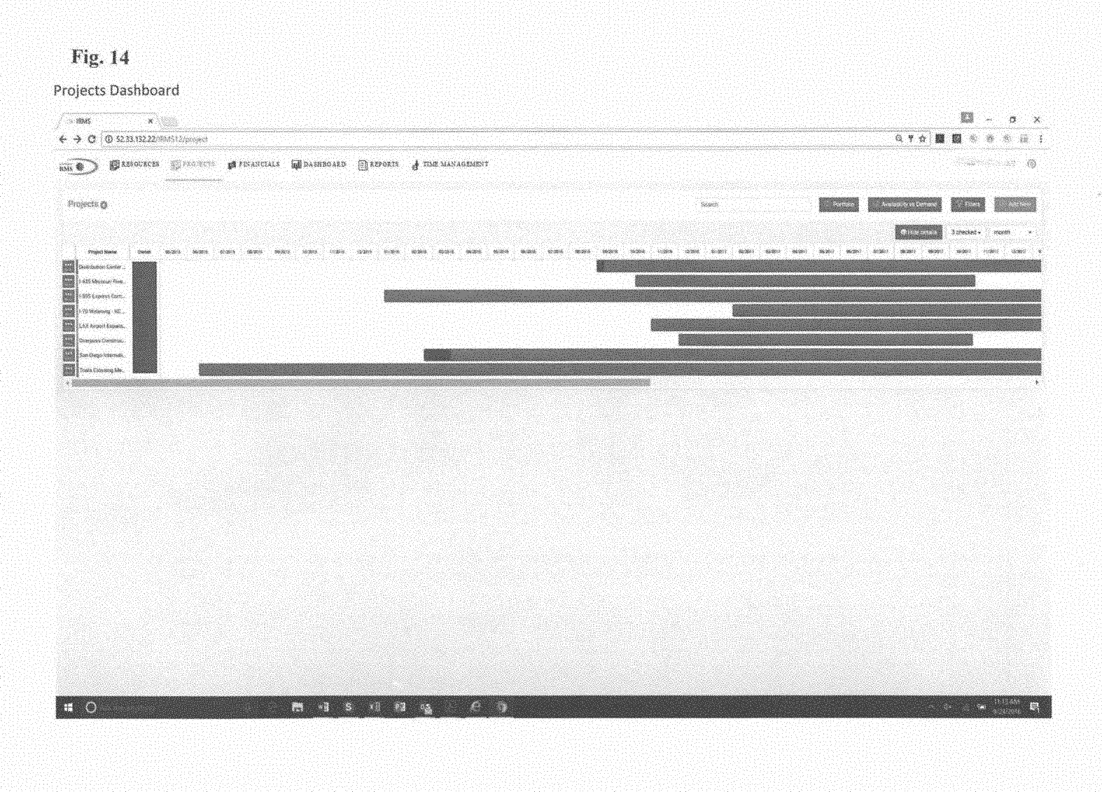

FIG. 13 are exemplary screenshots of an exemplary client project parameter of the system 10. The client project parameter presents information such as description of the project, start date, end date, estimated costs vs. actual costs and associated variances. Additionally, the client project parameter graphically displays different tasks of the project across a scheduled time period while graphically showing completed portions of a specific task within the graphical display. FIG. 14 is a screenshot out of a project dashboard of the system 10. The project dashboard presents information such as project names and graphical representation of the schedule for each specific project. The project dashboard further graphically shows percentage complete of the schedule for each specific project.

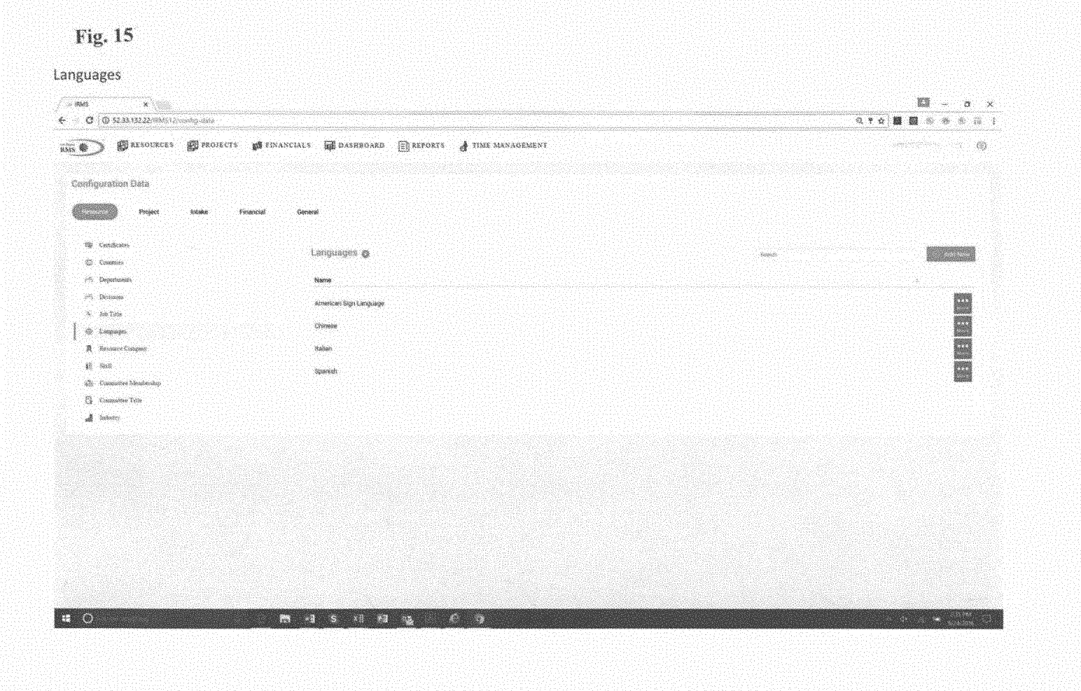

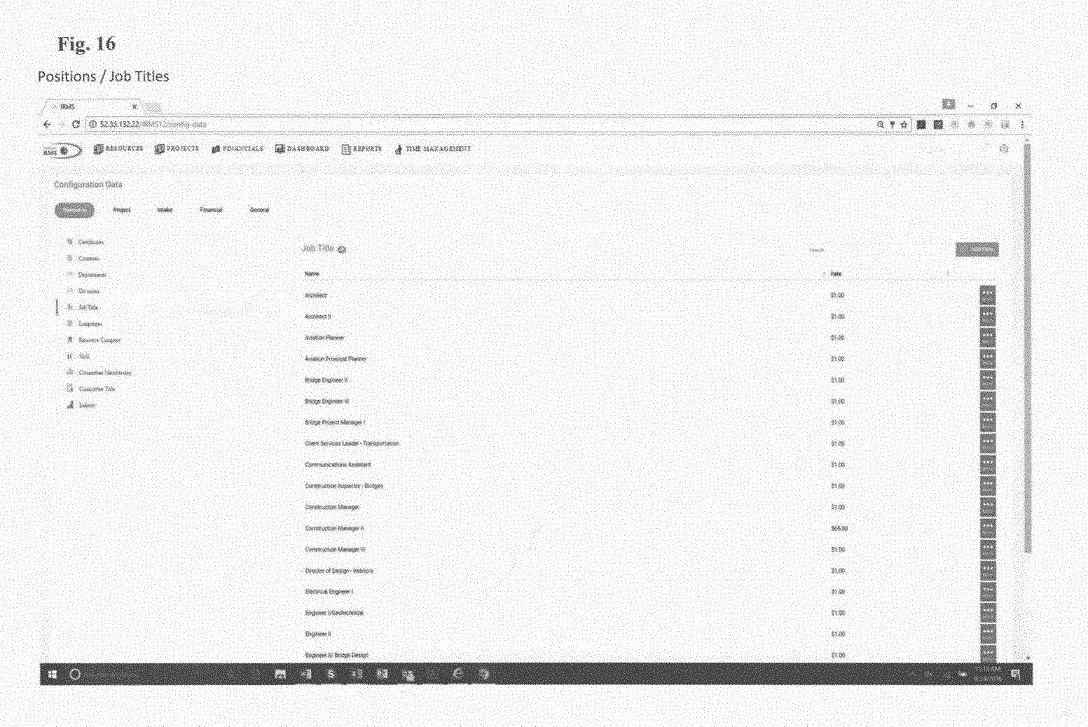

FIG. 15 is a screenshot of a language parameter of the system 10. The language parameter illustrates different languages needed by the client and/or language of the associate. FIG. 16 is a screenshot of a position/title parameter of the system 10. The position/job title parameter presents associate information and/or client information such as the names of job titles and specific categories along with associated rate per unit of each job title.

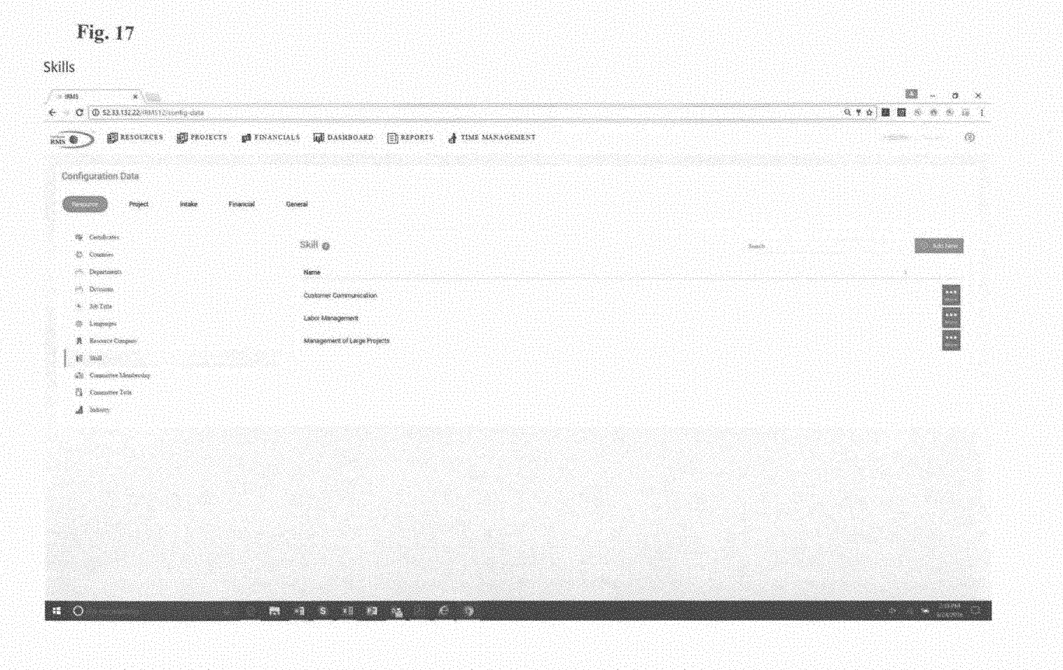

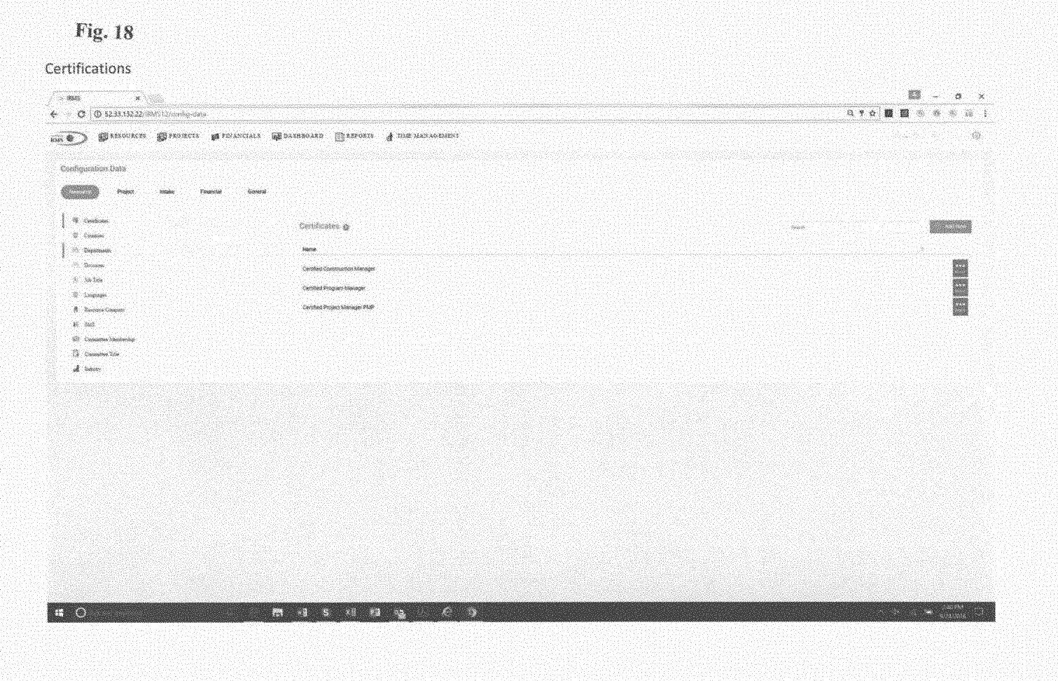

FIG. 17 is a screenshot of a skills parameter of the system 10. The skills parameter presents associate information and/or client information such as labor management skills, customer communication skills and large project management skills. FIG. 18 is a screenshot of a certification parameter of the system 10. The certification parameter presents associate information and/or client information such as certified construction manager, certified program manager and project manager PMP.

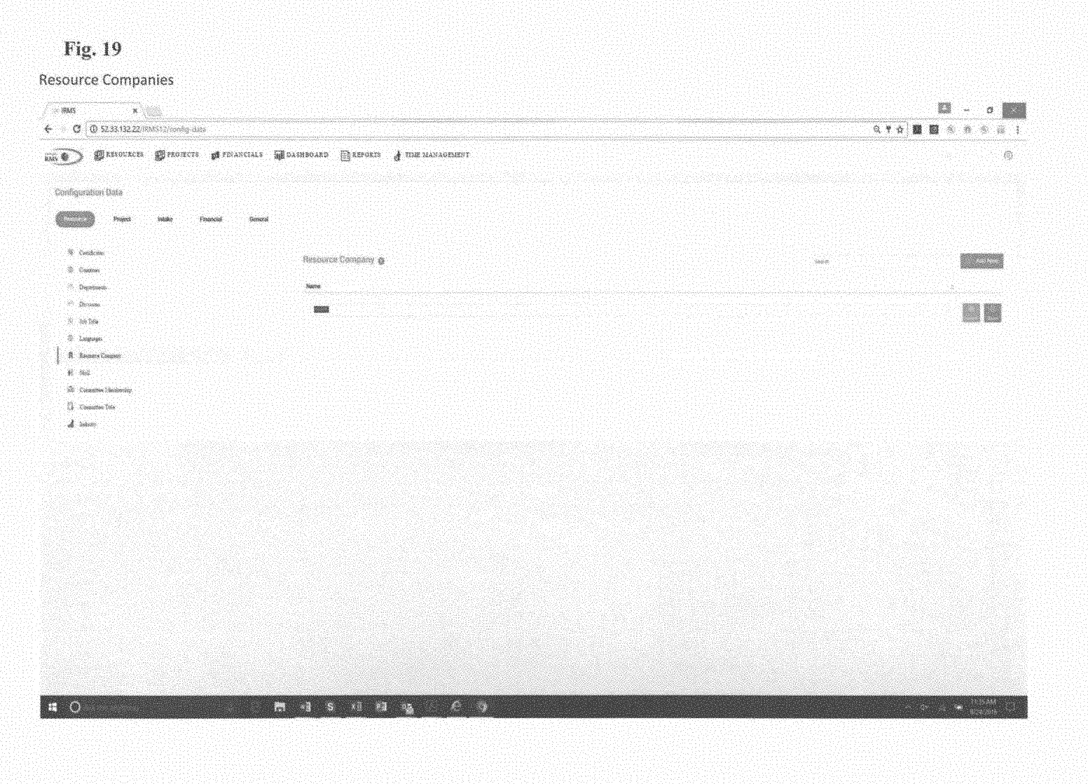

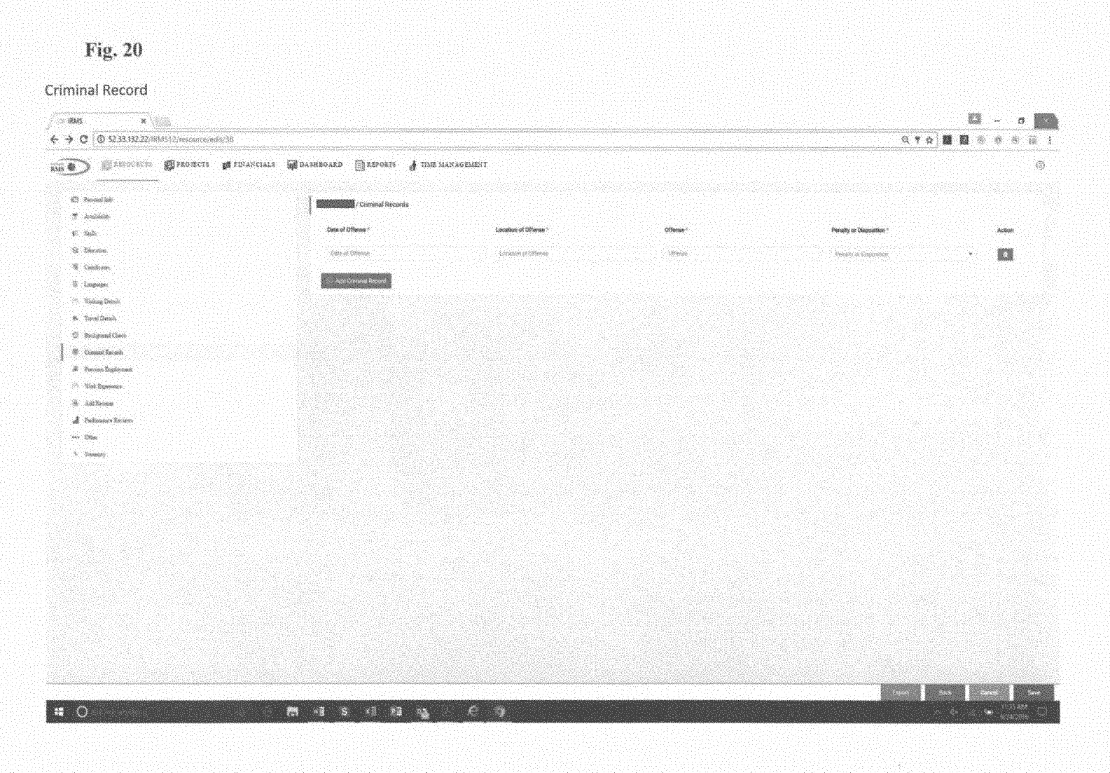

FIG. 19 is a screenshot of a resource company parameter of the system 10. FIG. 20 is a screenshot of a criminal record parameter of the system 10. The criminal record parameter presents information such as criminal offenses for an associate.

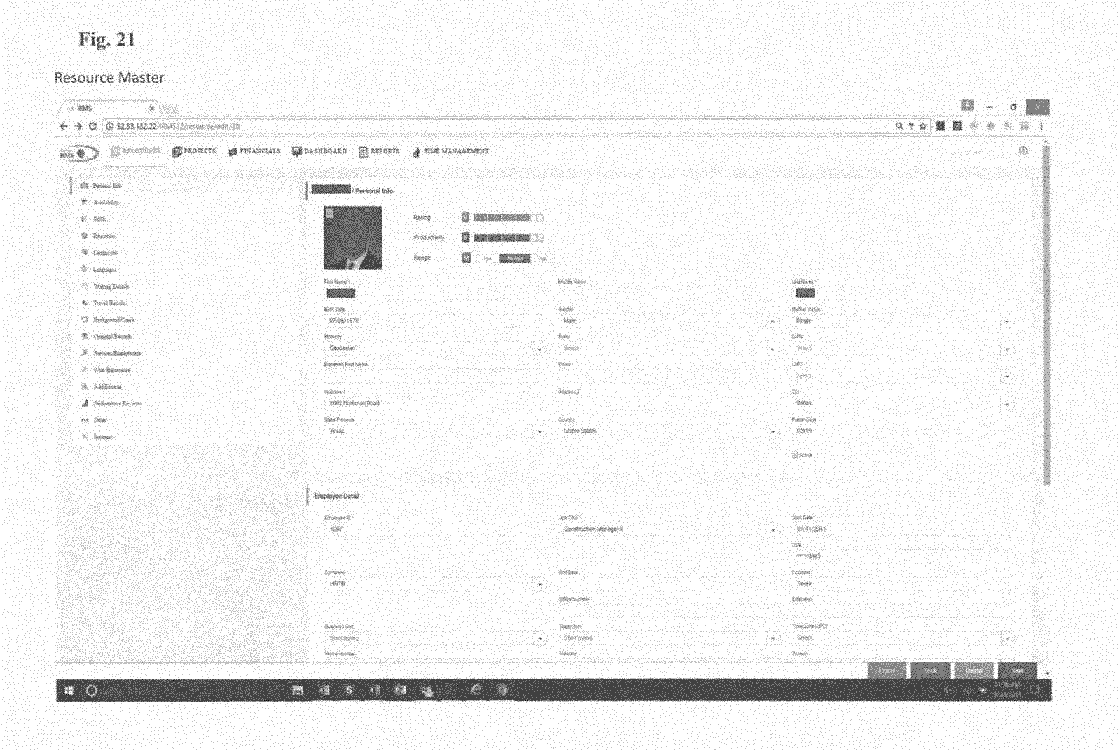

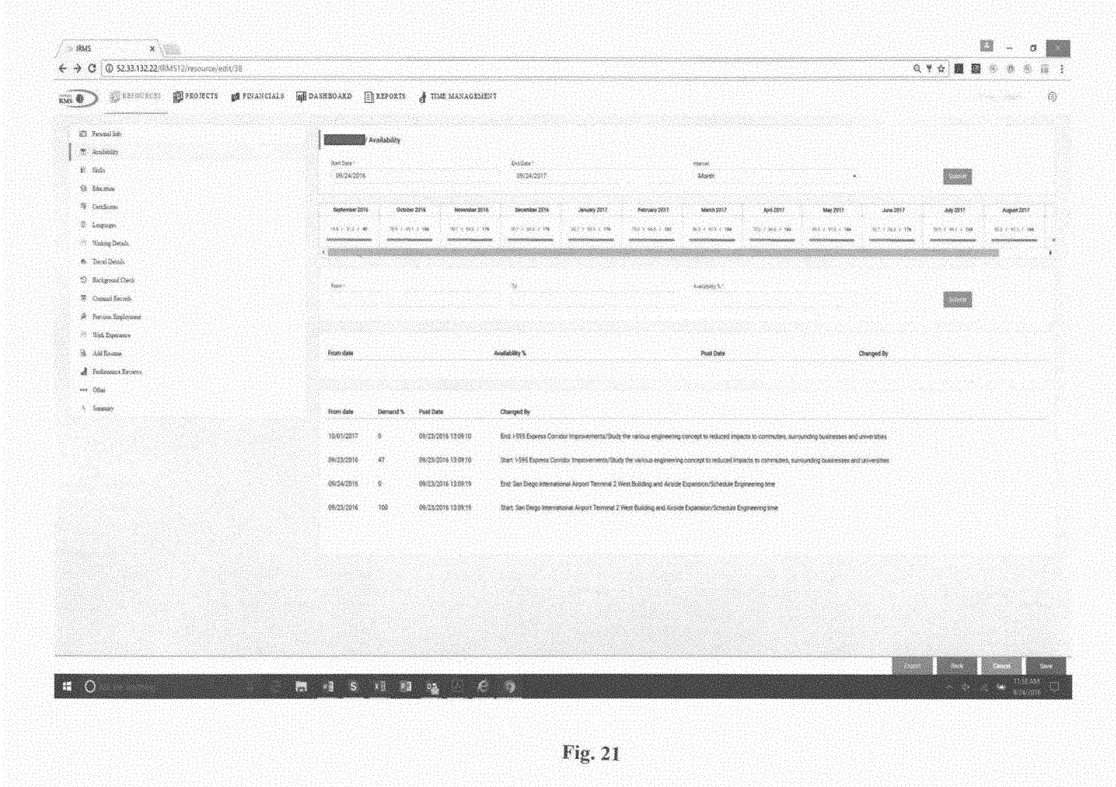

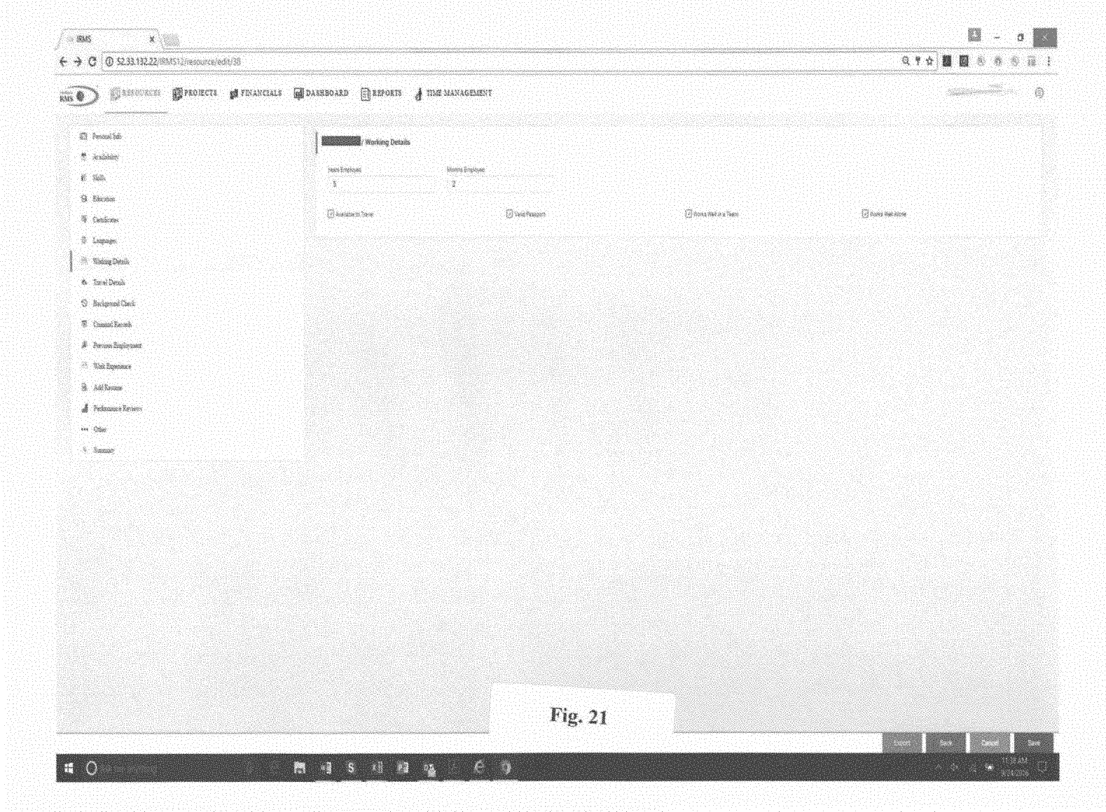

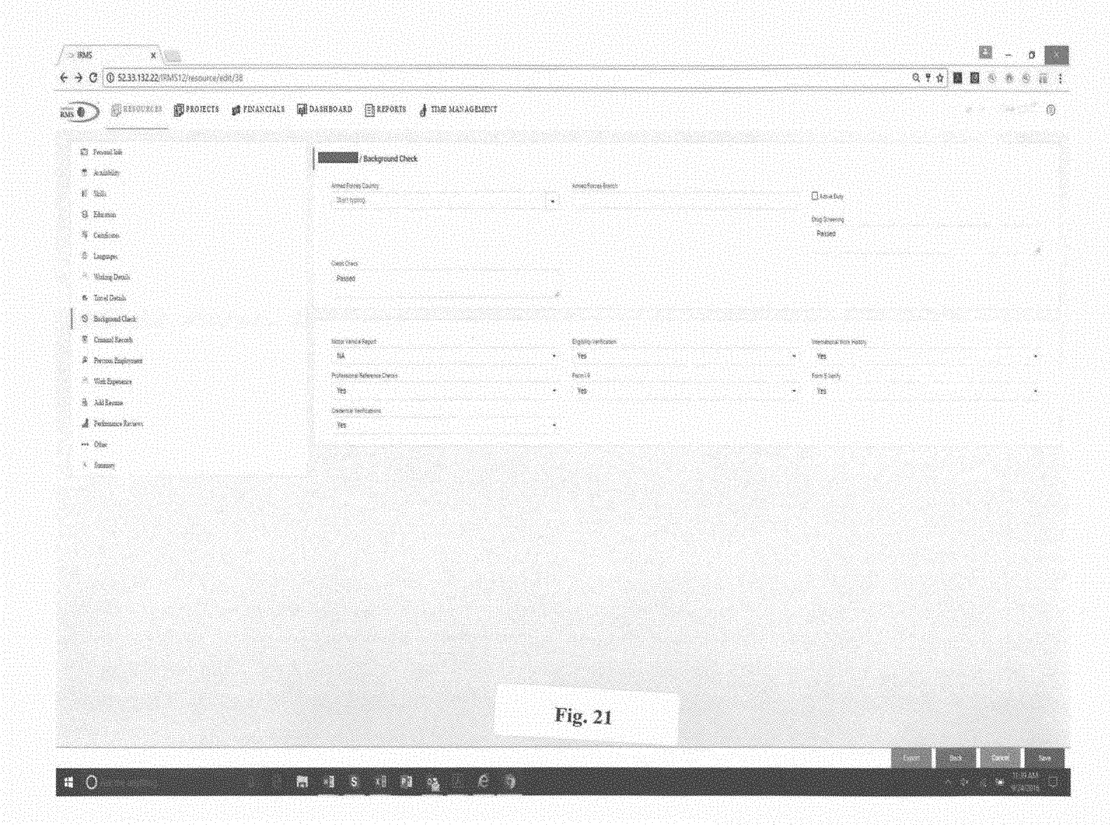

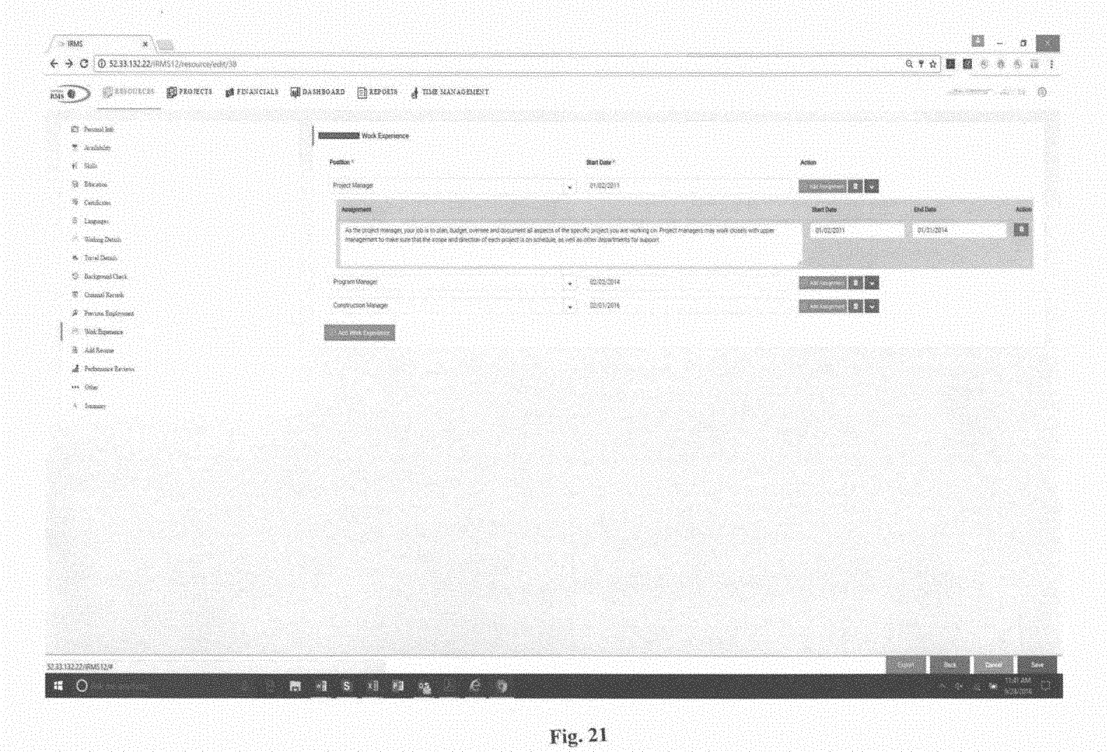

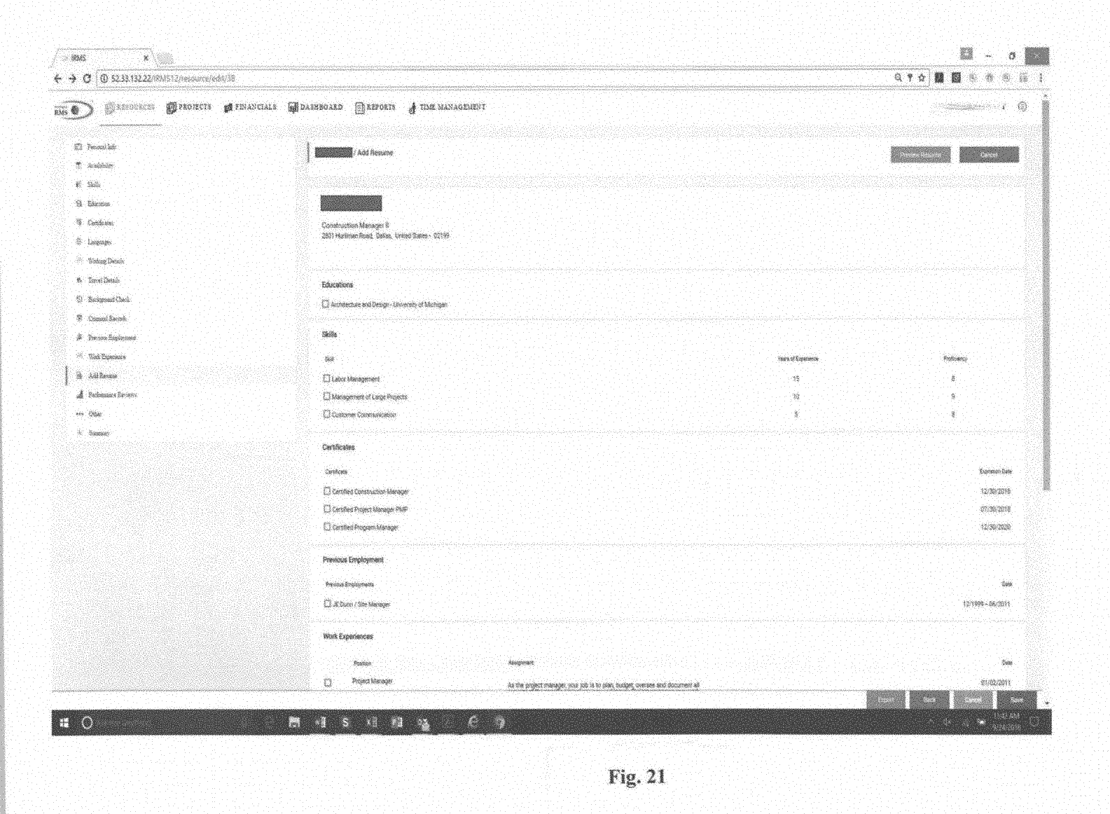

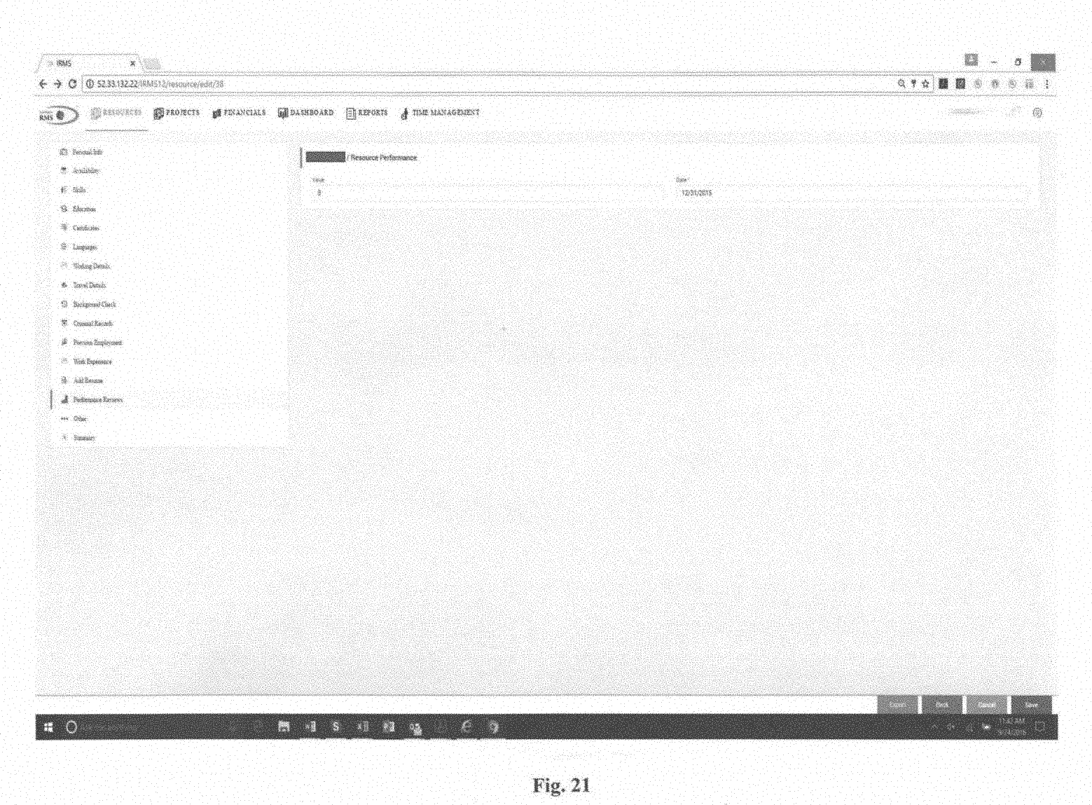

FIG. 21 illustrate screenshots of a resource master parameter of the system 10. The resource master parameter presents information such as personal information of the associate and/or employment information of the associate. The resource master parameter further presents information such as associate availability which can be graphically represented across monthly timelines. The resource master parameter can also illustrate background check information of the associate. The resource master parameter further presents work experience such as positions, years' experience, and assignments of the associate. The resource master parameter can also relate to the information required or desired by the client.

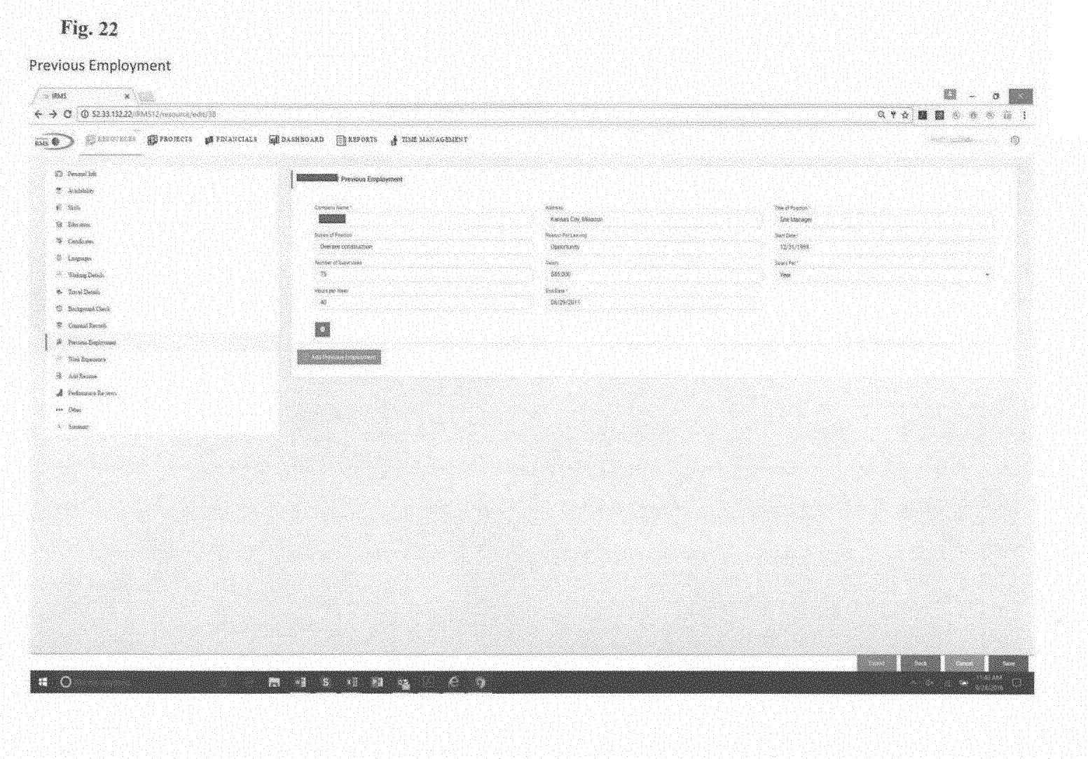

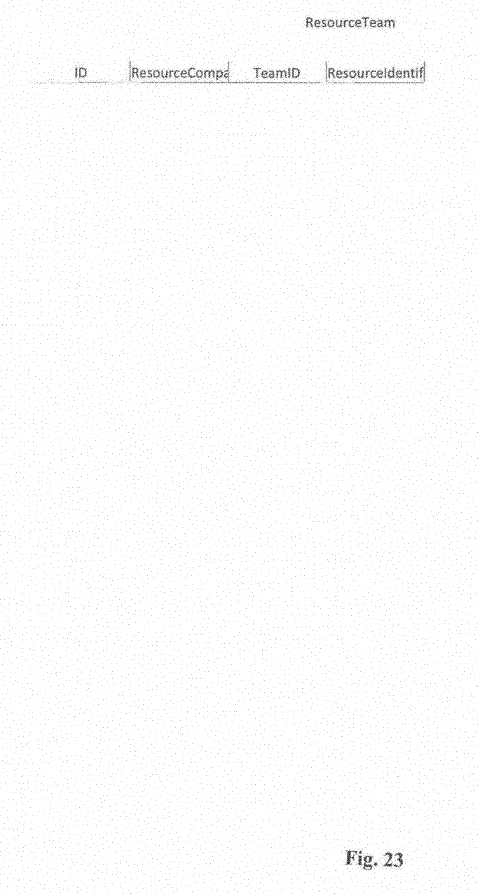

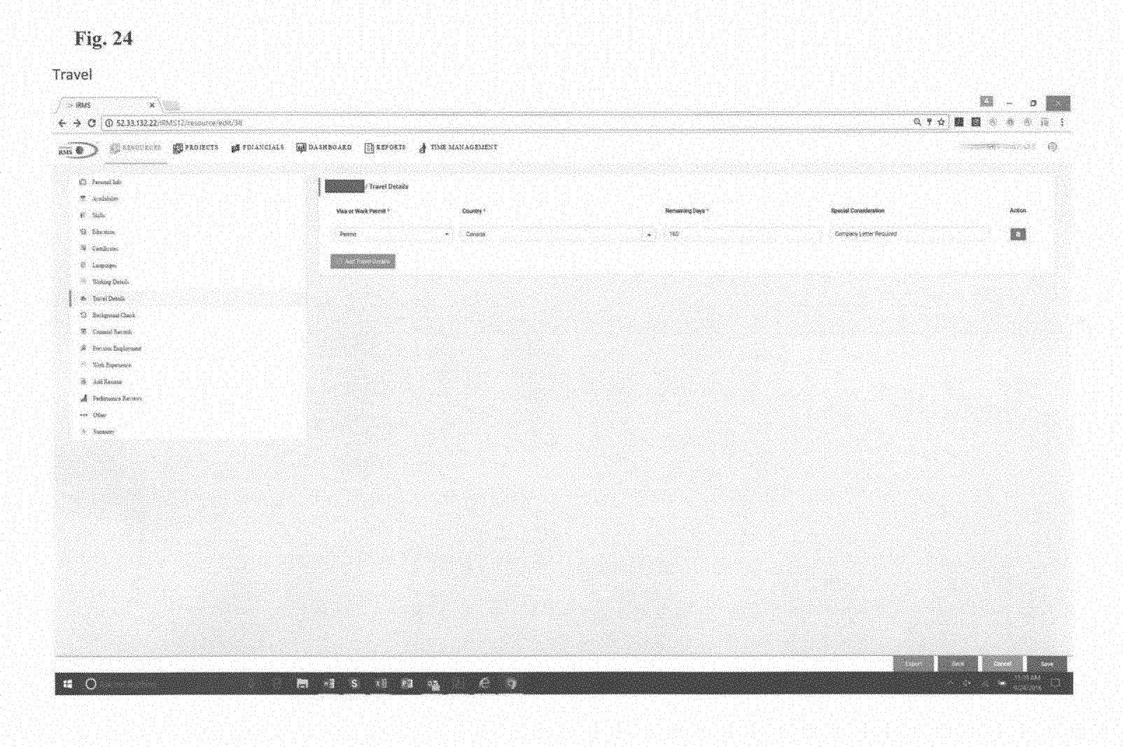

FIG. 22 is a screenshot of a resource previous employment parameter of the system 10. The resource previous employment parameter presents information such as previous companies' names and description of previous positions held by the associate. FIG. 23 is a screenshot of a resource team parameter. FIG. 24 is a screenshot of a resource travel parameter of the system 10. The resource travel parameter presents information such as travel details based on visa or work permit and related countries and remaining countries. The resource travel parameter can also present the remaining days of a visa or work permit of the associate.

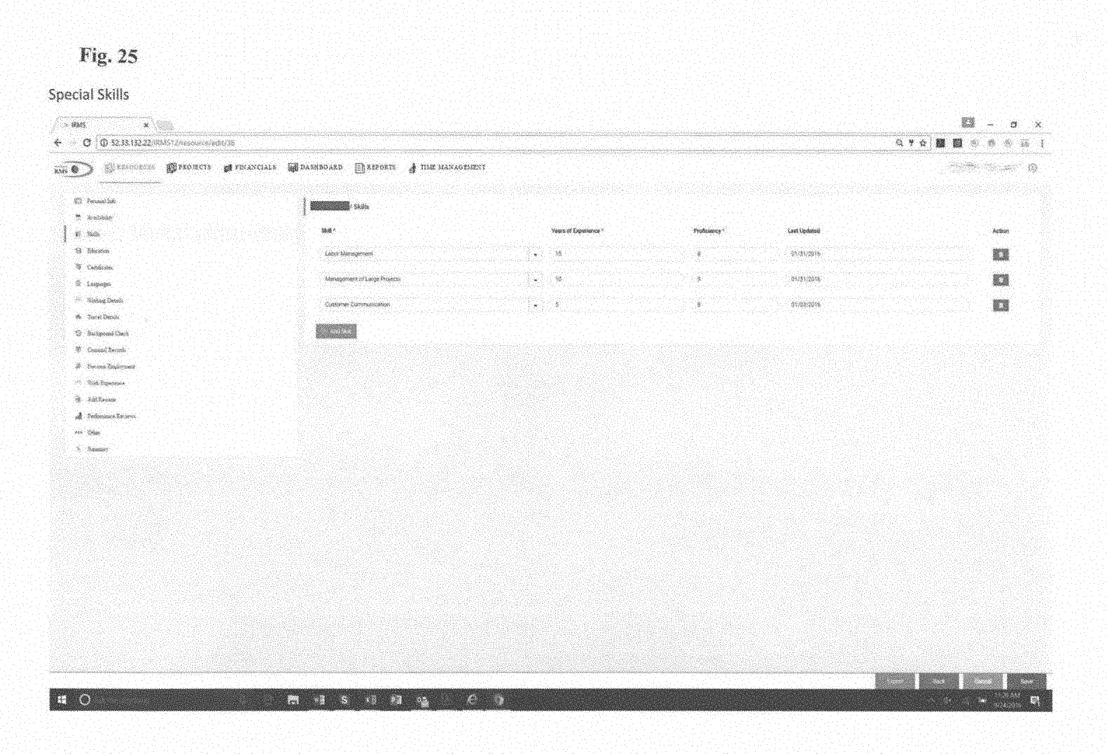

FIG. 25 is a screenshot of a special skills parameter of the system 10. The special skills parameter presents information such as specific skills of the associate, for example, experience and proficiency in a skill.

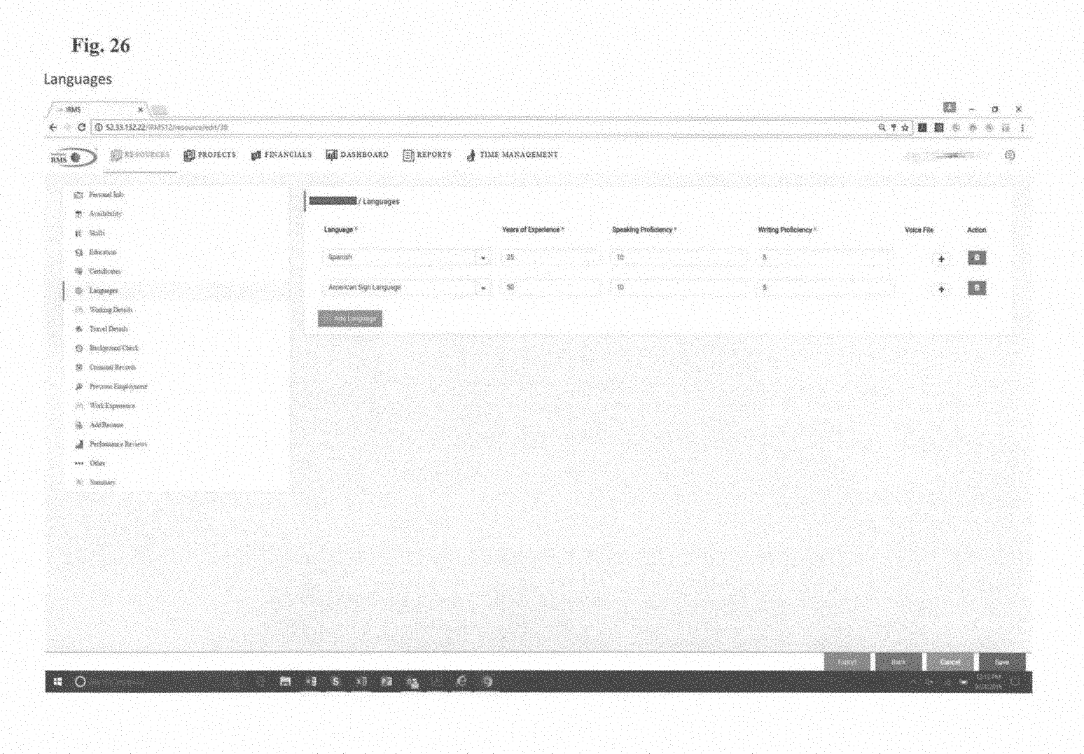

FIG. 26 is a screenshot of another spoken/written language parameter of the system 10. The spoken/written language parameter presents information such as language capabilities of the associate. For example, the spoken/written language parameter presents light ledge information including years of experience, speaking proficiency, and writing proficiency.

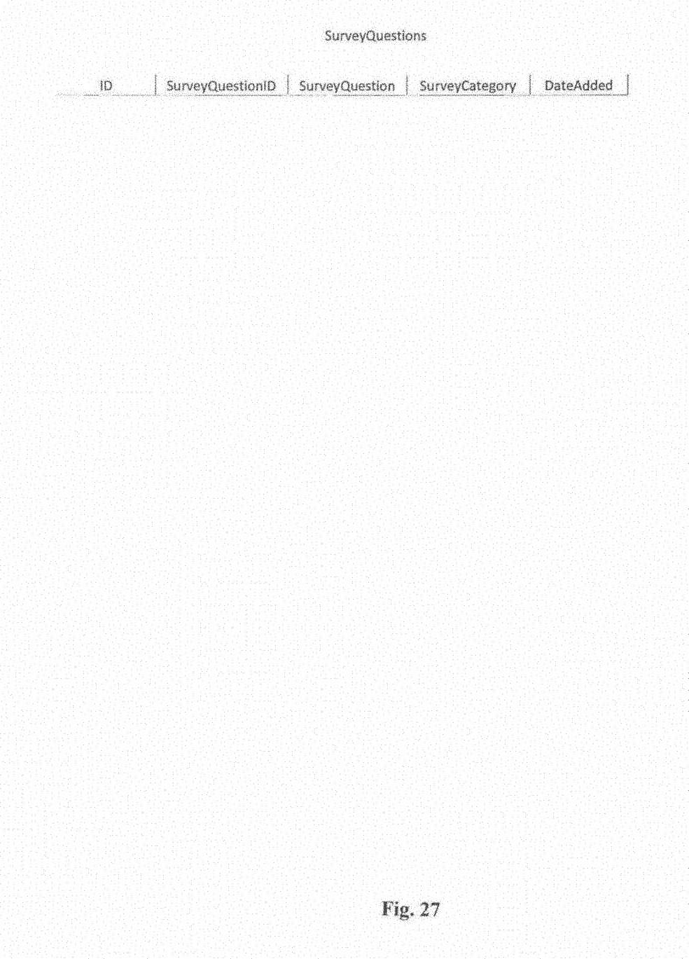

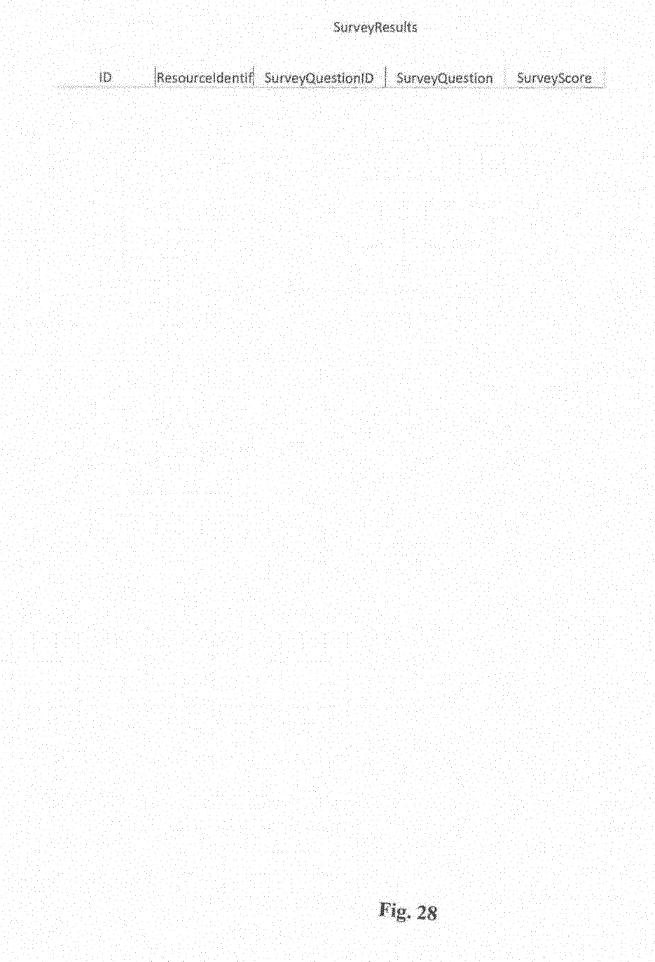

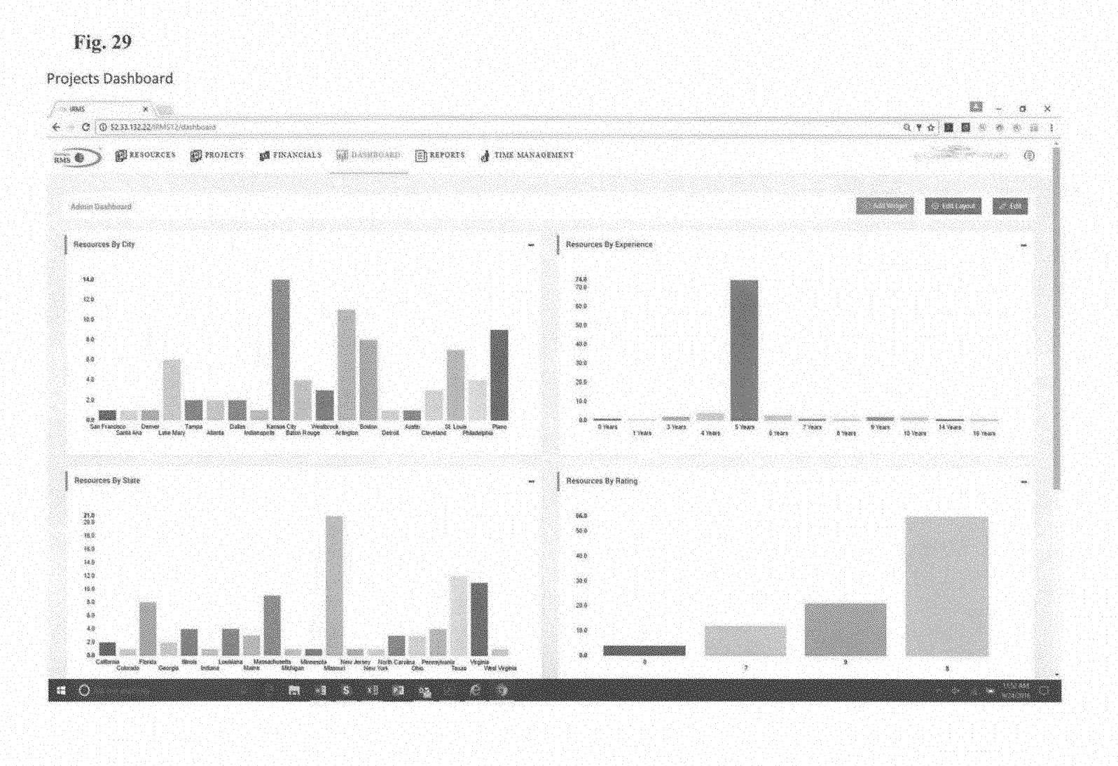

FIG. 27 is a screenshot of a survey question parameter of the system 10. FIG. 28 is a screenshot of a survey results parameter of the system 10. FIG. 29 is a projects-board parameter of the system 10. The projects-board parameter presents information relating to associate resources. More particularly, the project-board presents information relating to graphical representation of resources by city, resources by experience, resources by state, and resources by rating.

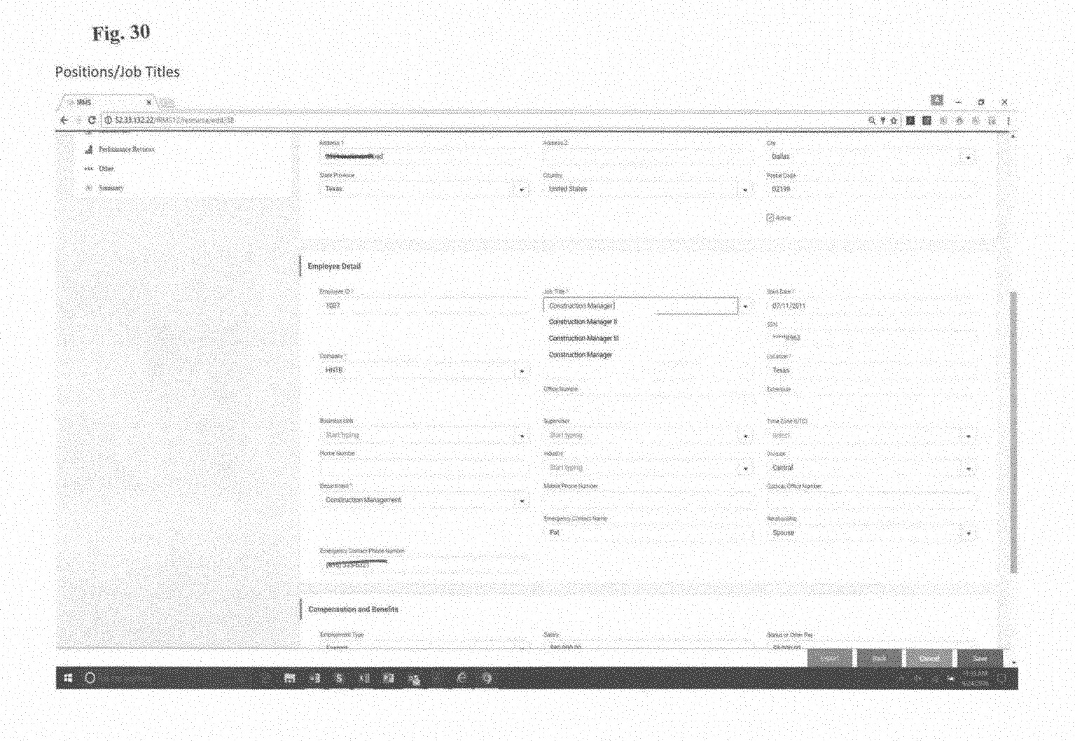

FIG. 30 is a position/job title parameter of the system 10. The position/job title parameter presents employee detail information such as for example employee identification number, job title, and start dates.

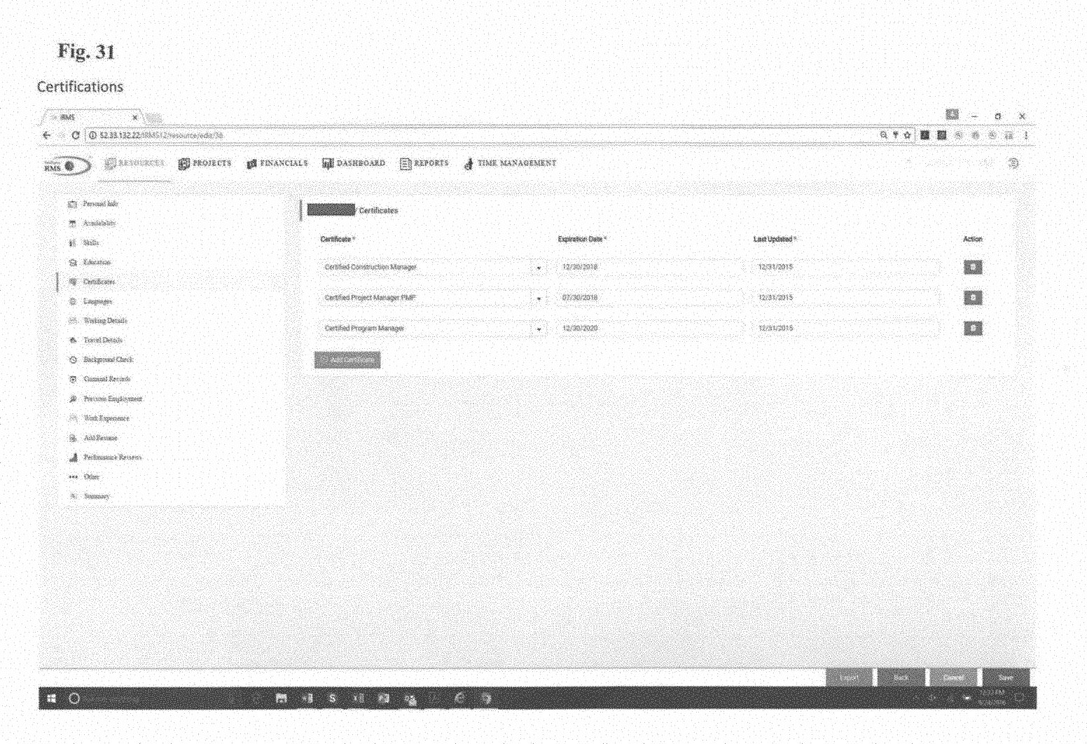

FIG. 31 is a screenshot of another certification parameter of the system 10. The certification parameter presents information such as certificates obtained by the associate, for example, certified construction manager, and certified program manager with associated expiration dates and last update detail.

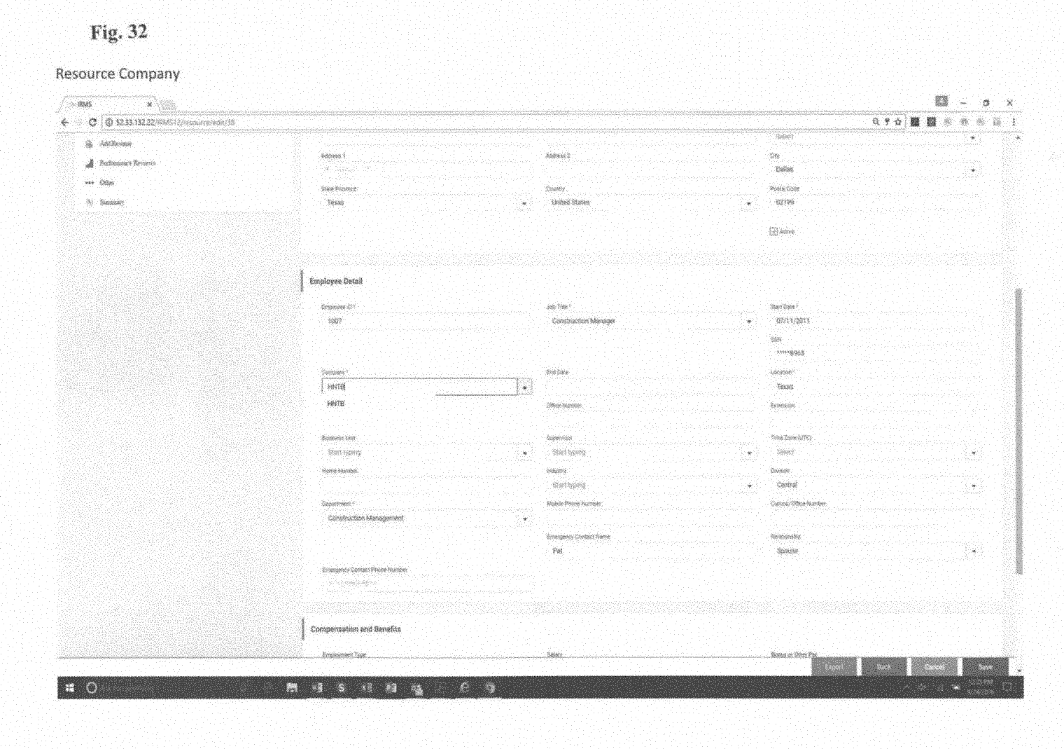

FIG. 32 is a screenshot of a resource company parameter of the system 10. The resource company parameter presents information such as associate job titles and departments.

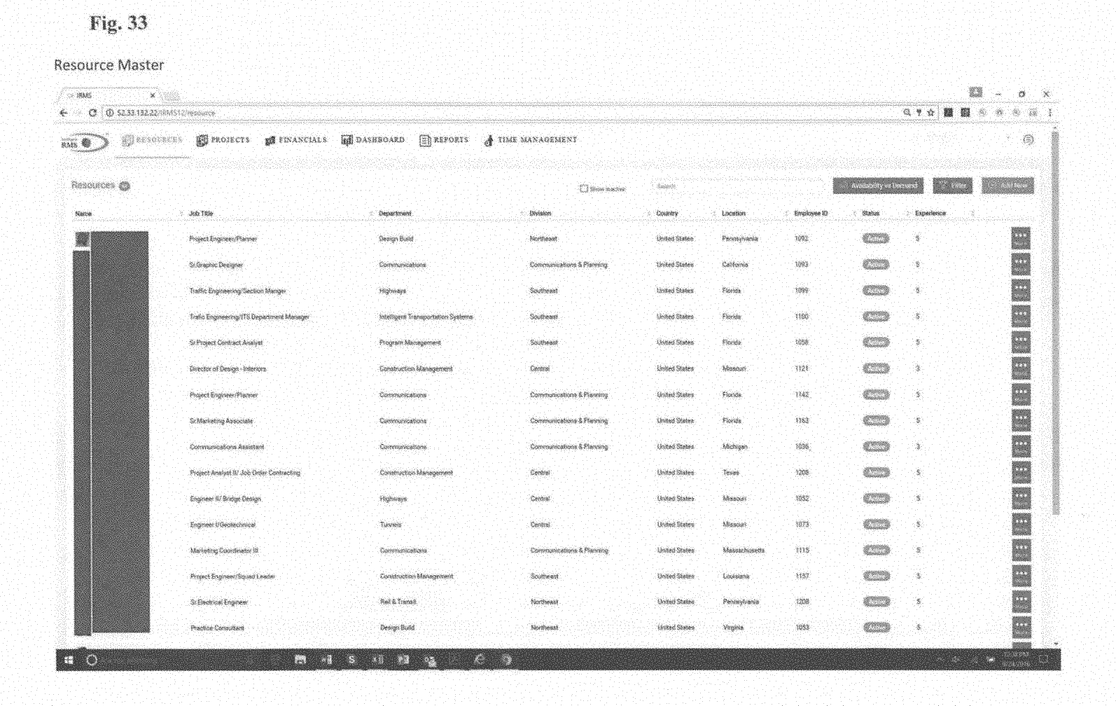

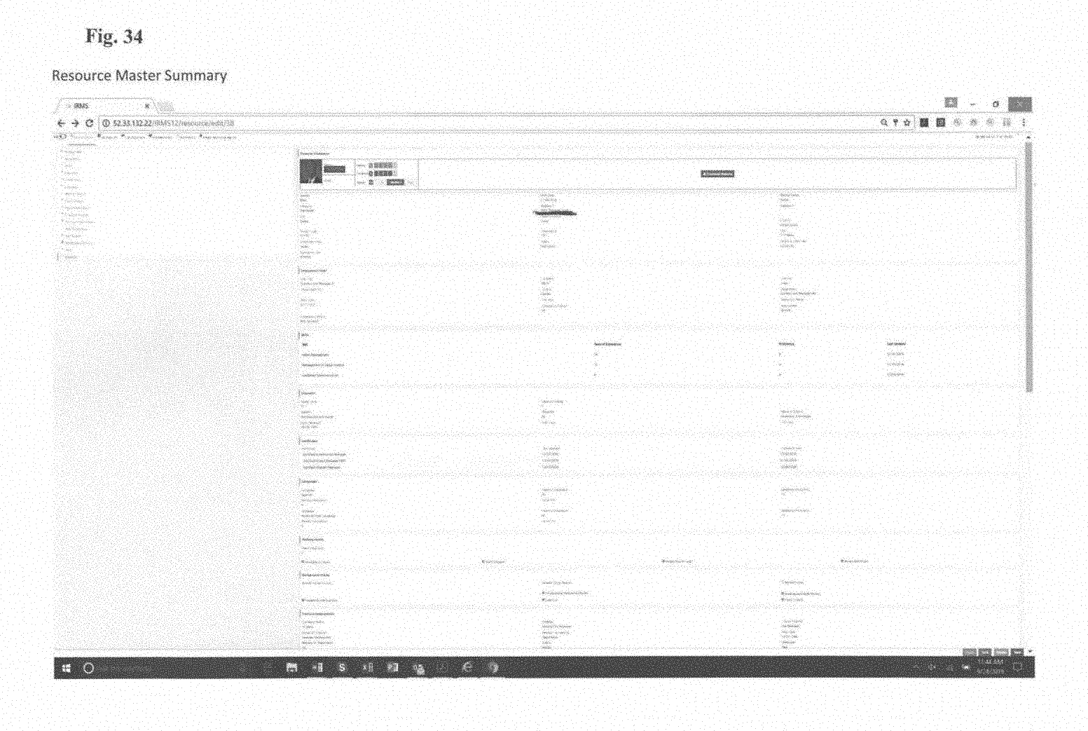

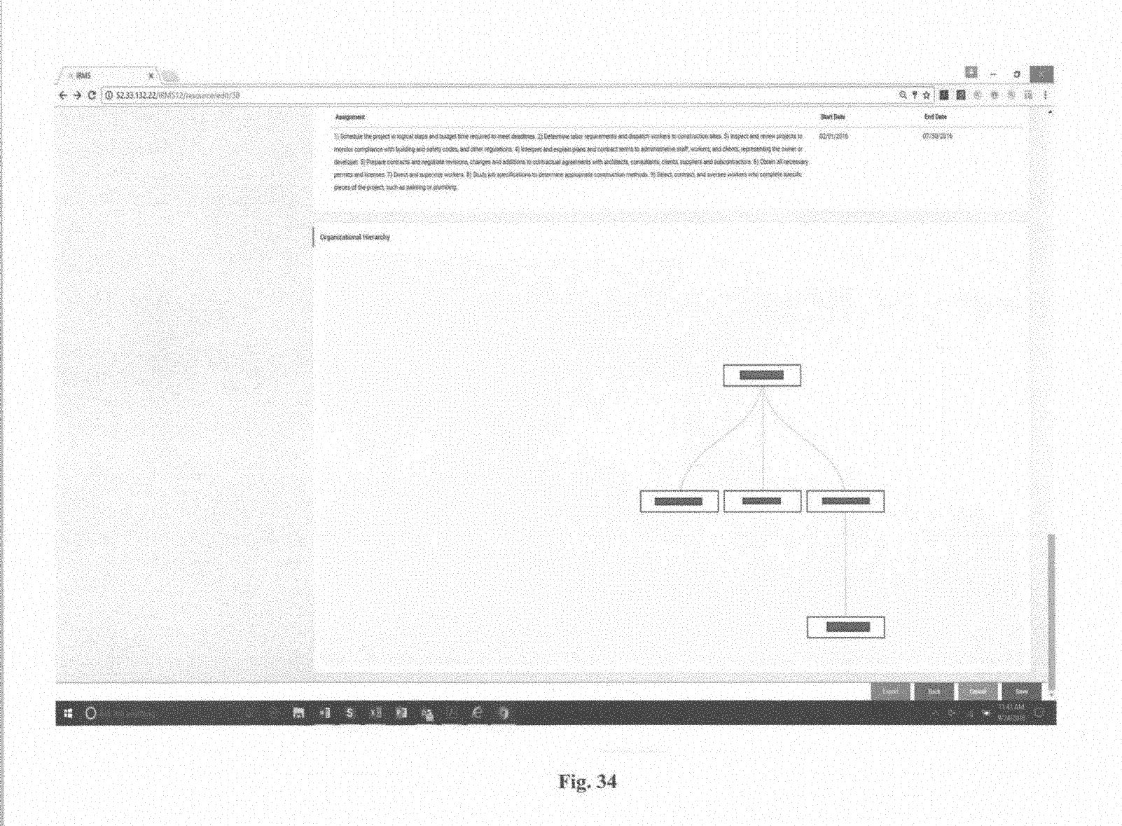

FIG. 33 illustrates screenshots of a resource master parameter of the system 10. The resource master summary parameter presents information as associate's job title, department, division, and location. FIG. 34 are screenshots of a resource master parameter of the system 10. The resource master summary parameter further provides assignment information for the associate.

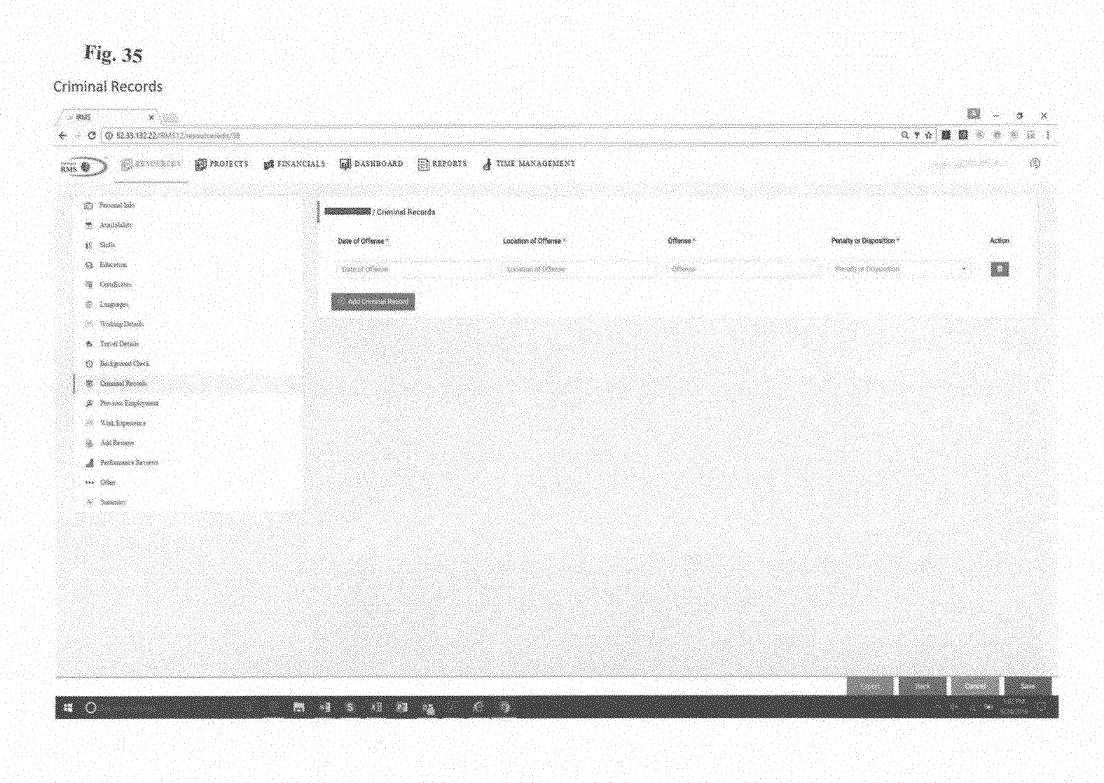

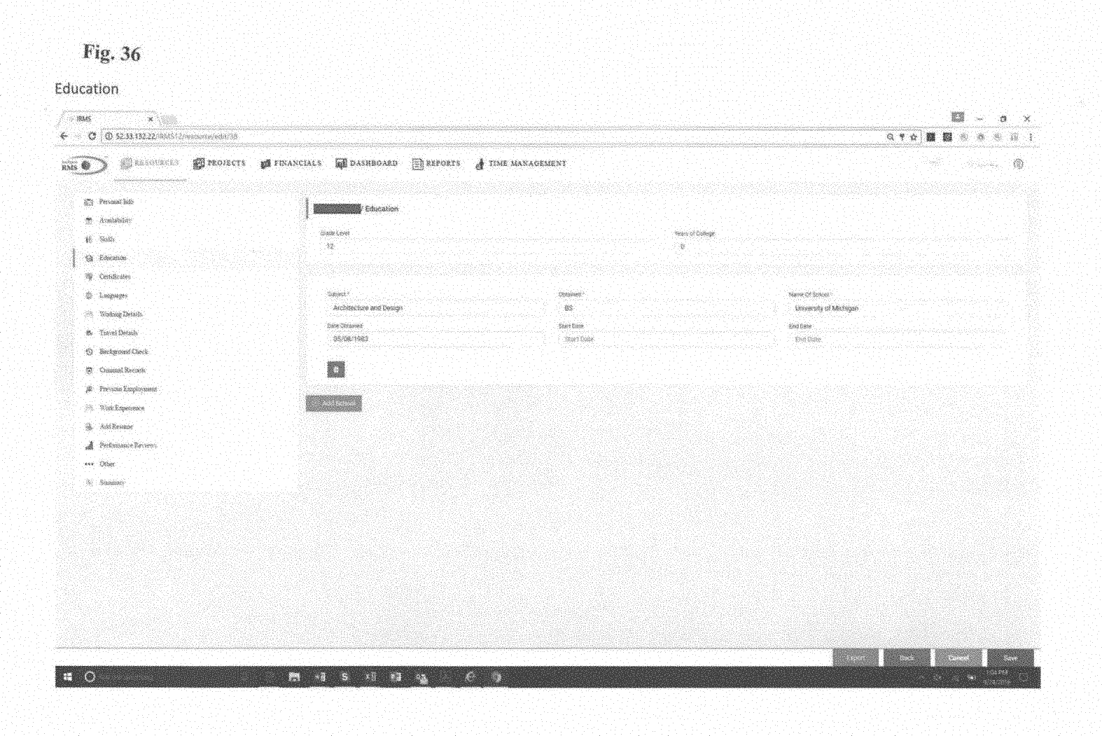

FIG. 35 is a screenshot of a criminal offense parameter of the system 10. The criminal record parameter presents information such as associate's date of offense, location of offense, the offense, and the penalty or disposition of the offense. FIG. 36 is a screenshot of an education parameter of the system 10. The education parameter presents information such as degrees obtained by the associate.

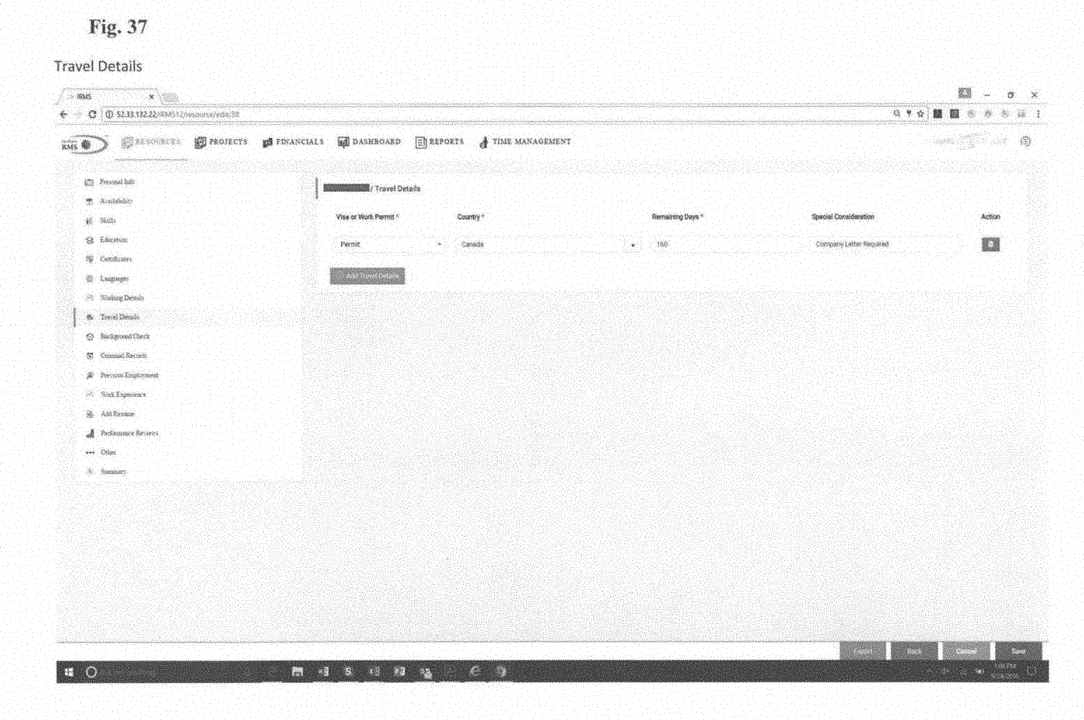

FIG. 37 is a screenshot of a travel detail parameter. The travel detail parameter presents information such as visa or work permit and associated country. The parameters presented in FIGS. 11-37 can relate to associate parameters received by the processor 14 as described in FIG. 2. Moreover, the parameters presented in FIGS. 11-37 can relate to client parameters received by the processor 14 as discussed in FIG. 3.

The present system and method uses parameters defined in a project plan template (application knowledge, skill set requirements, etc.) to build an algorithm in evaluating the pool of associates to identify the resources that meet the defined requirements. The quantity of application knowledge of the associates, the skill sets of the associates, and their availability is filtered by the application knowledge requirements of the project, the skill set requirements of the project and the projected dates and durations of the tasks. Applying knowledge such as the location of the associate relative to the customer, the availability of resources, and any other criteria important to the user the tool prioritizes the list of resources for the project.

A technical effect of the systems and methods described herein includes at least one of: (a) receiving a plurality of associate parameters; (b) storing the plurality of associate parameters on a database; (c) analyzing the plurality of associate parameters (d) assigning a ranking of the associate based at least on the plurality of associate parameters; (e) receiving a plurality of client parameters; performing a matching analysis by comparing the plurality of client parameters to the plurality of associate parameters (f); and, (g) assigning the associate to the client based at least on the matching analysis.

In the specification and the claims, reference will be made to a number of terms, which shall be defined to have the following meanings. The singular forms “a”, “an”, and “the” include plural references unless the context clearly dictates otherwise. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the term “computer” and related terms, for example, “computing device”, are not limited to integrated circuits referred to in the art as a computer, but broadly refers to a microcontroller, a microcomputer, a programmable logic controller (PLC), an application specific integrated circuit, and other programmable circuits, and these terms are used interchangeably herein. Further, as used herein, the terms “software” and “firmware” are interchangeable, and include any computer program stored in memory for execution by personal computers, workstations, clients and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non- transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

Processor is not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein. In the embodiments described herein, memory may include, but is not limited to, a computer- readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not limited to, a scanner. Furthermore, in the exemplary embodiment, additional output channels may include, but not be limited to, an operator interface monitor. The above examples are exemplary only, and thus are not intended to limit in any way the definition and/or meaning of the term processor.

Exemplary embodiments of resource management system are described herein. The methods and systems are not limited to the specific embodiments described herein, but rather, components of systems and/or steps of the methods may be utilized independently and separately from other components and/or steps described herein. For example, the methods may also be used in combination with other manufacturing systems and methods, and are not limited to practice with only the systems and methods as described herein. Rather, the exemplary embodiment may be implemented and utilized in connection with many task, project, and/or human resource applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer implemented method for managing resource information between an associate and a client relating to a client assignment, the method comprising:
receiving a plurality of associate parameters;
storing the plurality of associate parameters on a database;
analyzing the plurality of associate parameters;
assigning a ranking of the associate based at least on the plurality of associate parameters;
receiving a plurality of client or project parameters;
performing a matching analysis by comparing the plurality of client parameters to the plurality of associate parameters; and
assigning the associate to the client based at least on the matching analysis.

2. The computer implemented method of claim 1, further comprising updating another plurality of associate parameters to the database.

3. The computer implemented method of claim 1, further comprising conducting a background check of the associate based at least on the received plurality of parameters.

4. The computer implemented method of claim 1, further comprising sending a survey to the associate.

5. The computer implemented method of claim 1, further comprising receiving a survey result relating to the associate.

6. The computer implemented method of claim 4, further comprising updating the assigned ranking of the associate based at least on the survey result.

7. The computer implemented method of claim 1, wherein the plurality of associate parameters comprises at least one of a skills parameter, an experience parameter, a verbal and or written language parameter, a country/province/region of residence parameter, a background check parameter, a visa/work permit status information for each country worked parameter, a certifications parameter, an education parameter, a work experience parameter, a work behavioral parameter, a work availability parameter, a travel parameter, a resume parameter, an administrative time assignment parameter, a vacation parameter, paid time off parameter, a sick time parameter and a holiday time off parameter.

8. The computer implemented method of claim 1 wherein the plurality of client parameters comprises at least one of a skills parameter, a years of experience parameter; a proficiency parameter; a verbal/written language skills parameter; an education parameter; a background check parameter; a certifications parameter; an onsite or remote parameter; a start date/length of engagement parameter.

9. The computer implemented method of claim 1, further comprising analyzing a historical database relating to the associate and projecting a salary trend for the associate.

10. The computer implemented method of claim 1, further comprising calculating availability of the associate based on work hours over a period of time.

11. The computer implemented method of claim 1, further comprising calculating availability of the associate versus a demand of the associate based on a role of the associate over a period of time.

12. The computer implemented method of claim 1, further comprising determining a trend in associate development by analyzing at least one of a skill, a salary, and a certification of the associate.

13. The computer implemented method of claim 1, further comprising maintaining an associate attribute relating to a hiring criteria.

14. The computer implemented method of claim 13, wherein maintaining the associate attribute comprises upgrading at least one of a skill, an experience, a proficiency, a language and a work permit status of the associate.

15. The computer implemented method of claim 1, further comprising selecting a client reviewer of the client assignment.

16. The computer implemented method of claim 1, further comprising conducting a behavior analytics of the associate based on the plurality of associate parameters.

17. A computer device for managing resource information between an associate and a client relating to a client assignment, the computer device comprising:
a memory device configured to store the resource information;
an interface device coupled to the memory device and configured to receive input instructions;
a processor coupled to the memory device and the interface device, the processor programmed to:
receive a plurality of associate parameters;
store the plurality of associate parameters on a database;
analyze the plurality of associate parameters;
assign a ranking of the associate based at least on the plurality of associate parameters;
receive a plurality of client parameters;
perform a matching analysis by comparing the plurality of client parameters to the plurality of associate parameters; and
assign the associate to the client or project based at least on the matching analysis.

18. One or more non-transitory computer-readable media having computer- executable instructions embodied thereon for managing resource information using a computer device having a memory and a processor, wherein when executed by the processor, the computer-executable instructions cause the processor to:
receive a plurality of associate parameters;
store the plurality of associate parameters on a database;
analyze the plurality of associate parameters;
assign a ranking of the associate based at least on the plurality of associate parameters;
receive a plurality of client or project parameters;
perform a matching analysis by comparing the plurality of client parameters to the plurality of associate parameters; and
assign the associate to the client based at least on the matching analysis.
